(19) United States
(12) Patent Application Publication
(10) Pub. No.: US 2005/0210281 A1
(43) Pub. Date: Sep. 22, 2005

(54) Service system based on sensibility information

(75) Inventor: Hajime Enomoto, Funabashi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KAWASAKI (JP)

(21) Appl. No.: 10/946,036

(22) Filed: Sep. 22, 2004

(30) Foreign Application Priority Data
Mar. 12, 2004 (JP) 2004-071557

(51) Int. Cl. H04L 9/00; G06F 11/30; H04L 9/32; G06F 12/14

(52) U.S. Cl. 713/200

(57) ABSTRACT

The present invention evaluates the degree of satisfaction with a service of a client as a party of a system as sensibility information and provides the service based on the information.

The present invention comprises a unit 1 obtaining sensibility information about the service of each of at least a part of a plurality of parties, an intention realizing data processing device comprising a common platform as an interface function between an object network as a language processing function and each of the plurality of parties, realizing a service corresponding to the intention of the party, and a unit controlling each intention realizing data processing device to improve the degree of satisfaction with the service of each of the parties, using sensibility information of each of at least a part of the plurality of parties.

### BACKGROUND OF THE INVENTION

1. Field of the Invention

The present invention relates to a service system for providing/receiving services among a plurality of parties, and more particularly relates to a service system for realizing a service based on sensibility information indicating the degree of satisfaction for the service of a service receiver of the plurality of parties, using an intention realizing data processing device comprising a common platform as an interface function with a party and an object network for realizing the intention of the party.

2. Description of the Related Art

With the wide use of comprehensive network systems including the Internet, a service system for providing/receiving services among a plurality of parties using a network is being realized. For example, a system for providing multi-media data with a bi-directionality function and providing/receiving services among a plurality of parties through a network is being realized.

In such a multi-media service, a variety of information contents are being developed around games, and is coming into bloom. The Internet is widely developed using its mail function as an infrastructure, and is playing an important role in realizing services with ample security. In its application phase, financing, selling/buying, store management centering around a supermarket and a department store, energy conversion, operation services and the like are growing as infrastructure which is the base of the entire society.

There are innumerable target service areas, and there is an organic connection among the areas. A request for human resources that have a sufficient expertise for each service specialized in an area and are familiar with a data processing technology has rapidly increased. From the social point of view, co-operation among special parties in a variety of target areas ranging from physical distribution as a network, from human resource dispatching business, from lease, from outsourcing, to expertise education has become important.

In the above-mentioned situation, it is important for a party engaged in providing a clients as a user with services to sufficiently educate people in the special operation method of an expertise up to the building of cooperation as an organization, and to foster a group of coaches.

A service of providing information contents as multi-media and putting the information contents on a network provided with a security function, as a communication medium is regarded as a basic service. As its client application, there are financing, selling/buying and the client service of a store and the like, and both the diversification and integration of services are rapidly being promoted.

With the rapid promotion of the diversification and integration of services, the weight on the design support of related services, an operation support service and the like, and services for the entire system design, such as both the operation and control of materials, energy and products, the recruit and education of people and the like has rapidly increased.

With the trend of such diversification, service items have rapidly increased, and the special operation of new expertise and knowledge about cooperative operation become necessary. Furthermore, the fast training of coaches with an ability of tacit understanding is requested. The supplement of human resources that have a specialty in occupation, have knowledge sufficient to integrate such specialties as managers and coaches and have received such training is urgently requested.

The importance of a service specializing in business based on the knowledge of the scout of human sources and an expertise service including the spontaneous training of human resources has rapidly increased, and translation as a function to integrate the services is coming into existence as a new service.

Concerning such a service system using a network like this, the applicant has filed the following applications.
Patent Reference 1: Japanese Patent Laid-open Application No. 2002-290708 “Security Assurance Method in Service Function Execution System”
Patent Reference 2: Japanese Patent Laid-open Application No. 2003-308209 “Network Service System”
Patent Reference 3: Japanese Patent Application No. 2002-338721 “Service Effect Improving Method”

Patent Reference 1 discloses a system provided with an object network for executing a service function requested as a client intention, for assuring security without providing a special security system by checking matching constraints added to the template of an object.

Patent Reference 2 discloses a technology for efficiently and safely providing services on a network by collectively managing common data for providing/receiving services as comprehensive external environmental data in a system for providing/receiving services among a plurality of parties through a network, and enabling related parties to refer to the data at an arbitrary time.

Patent Reference 3 discloses a service effect improving method for effectively satisfying the intention of a party in order to improve a service effect in a service system for providing services among a plurality of parties.

However, even in such a service system, neither the degree of satisfaction appealing to the sensibility of a client as a party receiving a service of a plurality of parties can be measured nor the system can be evaluated, which is a problem.

A service is executed between a client receiving a service and a service provider providing the service. A target service area is selected according to the intention of a client. Some clients take consultation, such as a proposal and the like, on a target service and its specific goal from a service provider.

Major target service industry fields are IT (intelligence), materials, measurement/processing, environment, energy, life science, medical treatment, nursing care, agriculture/stock-breeding and transportation. Since the industry is currently diversified, the industry field of some client covers a plurality of fields. Therefore, in order to closely connect those fields to each other, the intention of a client must be satisfied by creating an advanced network with improved reliability. For that purpose, a protocol technology has been developed in a network, such as the Internet or the like, and the personalization of a network is promoted. Then, in order to improve the reliability of a network, the management of a network and its traffic, and an encryption technology has been introduced. Then, in order to provide for an effective network, a network designing method and quality evaluation have been introduced. Then, in order to satisfy the request intentions of clients, services have been improved to further lead to the creation of new services.

The above-mentioned diversification and hierarchization, and the reciprocal interaction of a variety of services are inevitable for the creation of new services. Therefore, the software service business is currently engaged in designing software including communication and biology, for the maintenance and outsourcing of services. However, the contents of software vary depending on a target system and affect the performance of the system. More particularly, the degree of client satisfaction varies depending on each client.

For these reasons, as to services specialized in a target area too, in order to provide services that sufficiently satisfy clients, a service provider must hierarchically organize the system and its human resources as an organization with the hierarchical structure of a system, such as a group of coaches that have special knowledge and expertise and can gradually improve their cooperation relationship together through friendly rivalry.

In order to realize such a service system, the present invention adopts a WELL (window-based elaboration language) system using a functional language called “WELL”. This WELL system can execute services in a variety of fields by using an object network system designed as a field descriptive language corresponding to each service field without being limited to a specific service field.

The object network system is modeled after data and a variety of operations performed for the data. This WELL system comprises a common platform as an interface with a variety of windows from which a user can issue instructions and data using this object network, and displaying the execution results of the system.

An intention realizing data processing device for realizing one of an independent intentions that a client can independently realize, a common intention that can be realized by the intention of one of a plurality of clients cooperatively operating with the other client's intentions and a contrary intention that one client's intention is contrary to the other client's intention is organized using such a WELL system. In the present invention, this intention realizing data processing device is basically provided for each of a plurality of parties of a service system.

Such a WELL system and an intention realizing data processing device are disclosed in the following patent references of the applicant as its prior applications.
Patent Reference 4: Japanese Patent Laid-open Application No. 9-297864 “Data Processing Device in Object Network”
Patent Reference 5: Japanese Patent Laid-open Application No. 11-312087 “Intention Realizing Data Processing Device”

It is an object of the present invention to provide a service system for evaluating the degree of service satisfaction of a client as a party of the service system as sensibility information and providing services, based on such sensibility information in order to solve the above-mentioned problems.

### SUMMARY OF THE INVENTION

The service system based on sensibility information of the present invention comprises a plurality of sensibility information acquisition units obtaining sensibility information, such as the degree of service satisfaction, of each of at least a part of a plurality of parties, such as clients, of the service system, a plurality of intention realizing data processing devices, each of which is an object-oriented data processing device for realizing services which satisfies the intention of each party, using the sensibility information obtained by the sensibility information acquisition unit for each of the plurality of parties, and a sensibility data adaptive integration unit controlling the plurality of intention realizing data processing devices to improve the degree of service satisfaction of each party, using the sensibility information obtained by the sensibility information acquisition unit corresponding to each of a part of the parties. Each intention realizing data processing device comprises a common platform as an interface function with a corresponding party, and an object network as a language processing function.

By obtaining sensibility information indicating the degree of satisfaction or the like, of a party as a client of a plurality of parties of the service system, the degree of service satisfaction of the party as a client can be improved.

### BRIEF DESCRIPTION OF THE DRAWINGS

FIG. 1 is a block diagram showing the basic configuration of the service system of the present invention;

FIG. 2 is a block diagram showing the basic configuration of the data processing device using an object network;

FIG. 3 explains a generic object network;

FIG. 4 explains a specific example of the object network;

FIG. 5 is a block diagram showing the detailed configuration of a noun object management mechanism;

FIG. 6 explains the execution of a specific function corresponding to a verb object;

FIG. 7 is a block diagram showing the basic configuration of the data processing device with a common platform as an interface with a user;

FIG. 8 explains a WELL system corresponding to a color picture generating/coloring process field;

FIG. 9 is a flowchart showing the data processing using an object network (No. 1);

FIG. 10 is a flowchart showing the data processing using an object network (No. 2);

FIG. 11 shows a color picture generating/coloring process method;

FIG. 12 shows an example of a template;

FIG. 13 shows an example of a template corresponding to a line segment;

FIG. 14 shows how to generate a specific object network from a generic object network;

FIG. 15 explains the definition of a role function;

FIG. 16 shows a process flow inside a WELL system for realizing an interactive function;

FIG. 17 is a flowchart showing the process of the interactive function;

FIG. 18 explains the interactive function between a leading role function and a support role function;

FIG. 19 explains an example of the matching prediction of a common intention;

FIG. 20 explains the matching/non-matching prediction of a contrary intention;

FIG. 21 explains the movement conversion by a strategy and tactics for a common intention/contrary intention;

FIG. 22 is a block diagram showing the summary of the entire structure of the intention realizing data processing device;

FIG. 23 explains the user process of an object network;

FIG. 24 explains the matching constraint relationship between a party and a driving system;

FIG. 25 explains the cell contents of the template of an object;

FIG. 26 shows the contents of a template for dynamically controlling a verb object;

FIG. 27 shows the definition structure of an intention;

FIG. 28 shows the entire configuration of a generic object network for realizing an intention;

FIG. 29 explains the connection structure between servers for expressing an intention;

FIG. 30 explains a communication function in the course of executing an intention;

FIG. 31 shows the flow of an intention realizing process by event drive;

FIG. 32 explains an interactive function by communication (No. 1);

FIG. 33 explains an interactive function by communication (No. 2);

FIG. 34 explains services by a reference model;

FIG. 35 explains a method for realizing a reference model by a WELL system;

FIG. 36 explains constraint description for “TEXTURED PICTURE” by graphic display and sentence structure;

FIG. 37 shows the flow of the sentence structure software of a “TEXTURED PICTURE”;

FIG. 38 is a block diagram showing the basic configuration of a service system based on sensibility information;

FIG. 39 explains the service integration method of sub-components;

FIG. 40 explains the adaptive operation of five fingers;

FIG. 41 explains a contour line vector and a force line vector corresponding to a free-form surface;

FIG. 42 explains structure lines indicating the features of a free-form surface;

FIG. 43 explains the area division of a human face;

FIG. 44 explains a process course structure executed by a plurality of role functions; and

FIG. 45 explains the loading onto a computer of a program for realizing the present invention.

### DESCRIPTION OF THE PREFERRED EMBODIMENTS

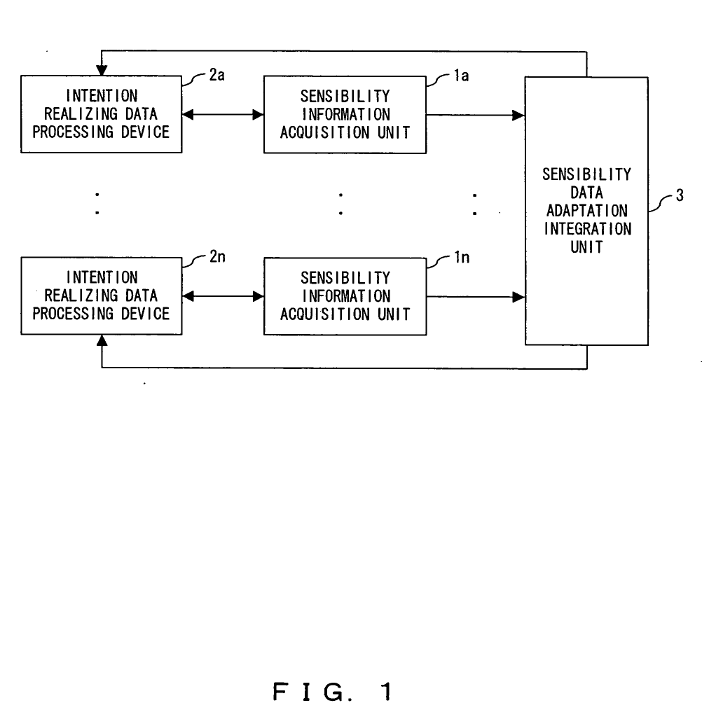

FIG. 1 is a block diagram showing the basic configuration of the service system of the present invention. FIG. 1 is a block diagram showing the basic configuration of a system for realizing integrated services corresponding to the intentions of a plurality of parties. For example, a part of the plurality of parties is clients receiving such services and the other part is service providers providing services.

In FIG. 1, sensibility information obtaining units 1ₐ, . . . , 1ₙ correspond to at least a part of the plurality of parties, such as clients, and obtain sensibility information, such as the degree of service satisfaction of parties. Intention realizing data processing devices 2ₐ, . . . , 2ₙ correspond to the parties, and are object-oriented data processing devices for realizing services corresponding to the intentions of the parties using sensibility information obtained by the sensibility information acquisition units. Each intention realizing data processing devices 2ₐ, . . . , 2ₙ comprises a common platform as an interface function between the parties and an object network as a language processing function.

A sensibility data adaptive integration unit 3 controls each intention realizing data processing device using the sensibility information obtained by the sensibility information obtaining unit 1 corresponding to each of the part of the parties so as to improve the degree of service satisfaction of each party. The sensibility information obtaining units 2ₐ, . . . , 2ₙ correspond to all the plurality of parties, each of which is provided with each sensibility information obtaining units 2ₐ, . . . , 2ₙ. The sensibility data adaptive integration unit 3 uses the sensibility information of all the parties.

Another preferred embodiment of the present invention can have a hierarchical structure composed of a data model in which the attribute structure of the object-oriented object is determined as a template, an object model which is positioned in order higher than the data model, a role model which is positioned in order higher than the object model and expresses the contents of a process to be performed in such an environment as an aggregate of a plurality of object models, and a process model which is positioned in the highest order and defines a dynamic process cooperatively performed by a plurality of role models as a process.

In another preferred embodiment of the present invention, the sensibility information obtaining unit can divide a target area from which the sensibility information about a service is obtained into partial areas and data is added to the feature concept of each partial area. Simultaneously, the intention realizing data processing device can relate each of the feature concept to each role model and execute a process defined by a process model corresponding to the role model.

In another preferred embodiment, the common platform can display data indicating the execution status of a service, and simultaneously the intention realizing data processing device can further comprise a process status output unit outputting the execution status as information including voice. In this preferred embodiment, matching constraint items can also be set in the object of each model as the attribute of the object, and simultaneously the intention realizing data processing device can also comprise a matching determination unit determining matching constraint items corresponding to the purpose of a service.

Furthermore, another preferred embodiment can further comprise a reference model which is orthogonal to the hierarchical structure composed of a data model, an object model, a role model and a process model, realizing a basic service to be executed in the process of an object network, and the intention realizing data processing device can also comprise a contents generation unit generating contents, based on the simulation data that is realized by the reference model and display the contents.

According to the present invention, services are executed based on sensibility information about each service of a party as a client.

In order to use the intention realizing data processing device as the basic component of a service system in this preferred embodiment, firstly this data processing device is described in detail.

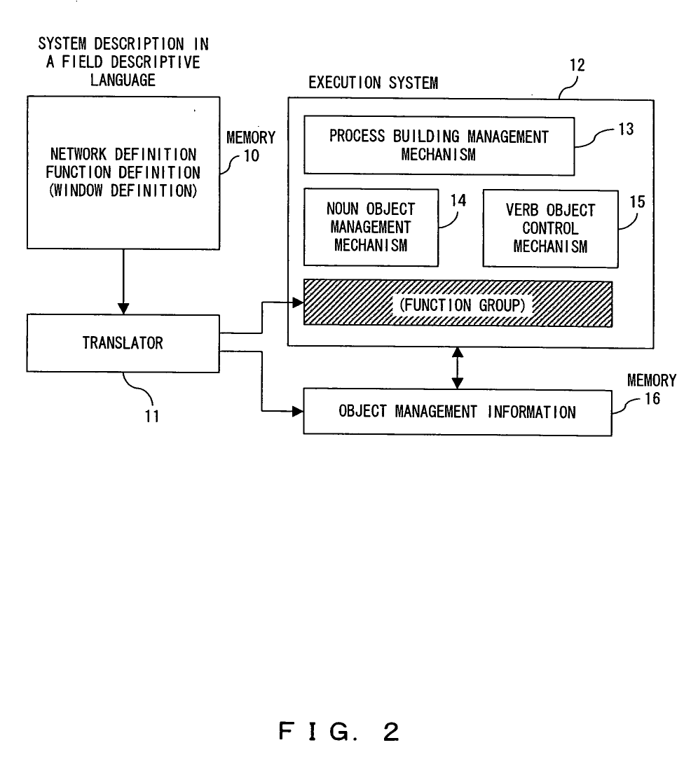

FIG. 2 is a block diagram showing the basic configuration of a data processing device using an object network. In FIG. 2, the data processing device comprises memory 10 storing a system description described in a field descriptive language, a translator 11 receiving the input of the system description, analyzing its sentence structure and generating data for an execution system 12, an execution system 12 and memory 16 storing the management information of the object network of the data generated by the translator.

The memory 10 storing a system description in a field descriptive language stores the definition of an object network, the definition of necessary functions, the definitions of windows and the like. The window is described later with reference to a common platform, which is also described later.

The execution system 12 comprises a process organization/management mechanism 13 controlling the parallel processing of processes and the like, a noun object management mechanism 14 managing noun objects of objects constituting the object network, and a verb object control mechanism 15 similarly having the execution function of verb objects.

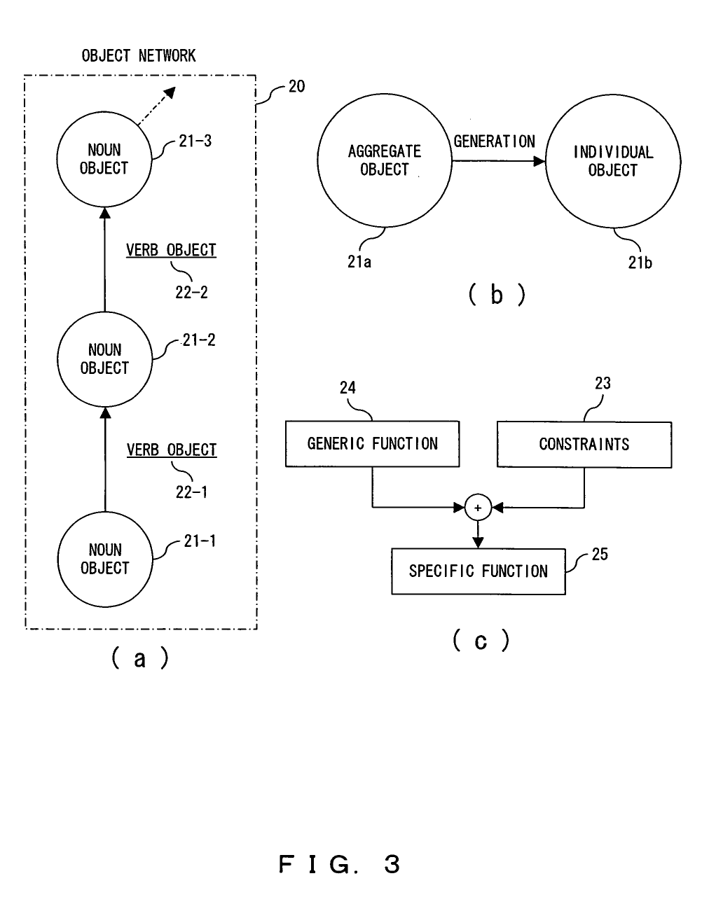

FIG. 3 explains a generic object network. The object network manages data in the data processing device and an operating means of the data as objects. The objects are largely classified into two types of a noun object and a verb object. As shown in FIG. 3A, an object network 20 in which noun and verb objects are expressed as a node and a branch, respectively, is built. The network is built so that if the contents of a function corresponding to a verb object as a branch is acted on a noun object as a node located on this object network, a noun object on the tip of a branch corresponding to the verb object can be obtained as a target.

As shown in FIG. 3B, a noun object 21 includes an aggregate object 21a corresponding to a common noun and an individual object 21b corresponding to a proper noun. The individual object 21b is generated from the aggregate object 21a.

As shown in FIG. 3C, the verb object includes two types of a generic function 24 and a specific function 25. When obtaining a noun object as a target, the specific function 25 can actually apply a process to a noun object. The specific function 25 can be obtained by adding constraints 23 to the generic function 24. Conversion from this generic function to the specific function 25 is controlled by a verb object control mechanism 15.

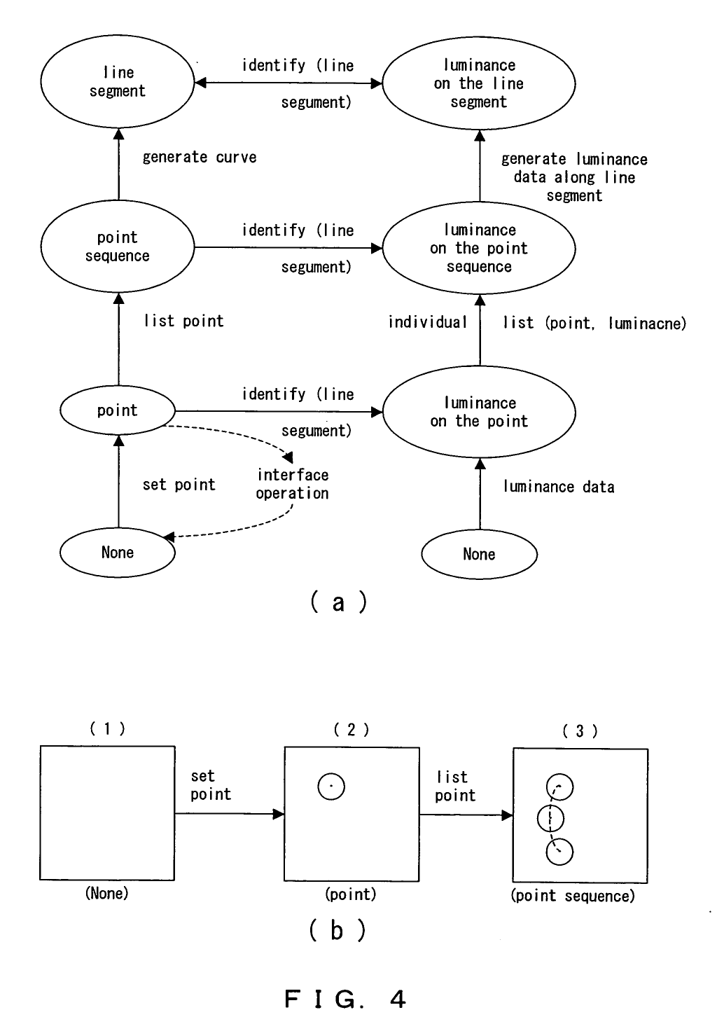

FIG. 4 explains a specific example of the object network. This network is for a case where the system description in a field descriptive language belongs to a picture field and is an object network for painting a picture. The left and right sides of FIG. 4(a) show an item network and an attribute network, respectively. The object network is composed of these two networks.

Firstly the item network in the left side of FIG. 4(a) is described. As shown in FIG. 4(b), a picture is painted in a status (1) where there is nothing. For example, if a user designates a point on a display by a mouse or the like, an operation corresponding to a verb object “to set points” is performed, and a noun object “points” is obtained. For example, a plurality of points corresponding to “set points” are plotted by an interface operation with a user, and by applying an operation corresponding to a verb object “to list points” to these points, a noun object “point sequence” shown in (3) is obtained. Furthermore, by acting a verb object “to generate a curve” on this noun object, for example, a corresponding noun object “line segment” is obtained.

The attribute network in the right side of FIG. 4(a) applies colors when painting, in correspondence with the item network on the left side, and each noun object located on the network is identified by a corresponding noun object on the item network. On the attribute network too, a noun object “luminance on the point” for designating luminance for each point is obtained from a status where there is nothing, by the operation of a verb object “to luminance data” on each point to this noun object. Further by applying “to list an individual list” and “to designate luminance for the point”, a noun object “luminance on the point sequence” is obtained. By further the operation of a verb object “to generate luminance data along a line segment on the noun object, a noun object “luminance on the line segment” is obtained. Then, based on that, a color picture is finally obtained.

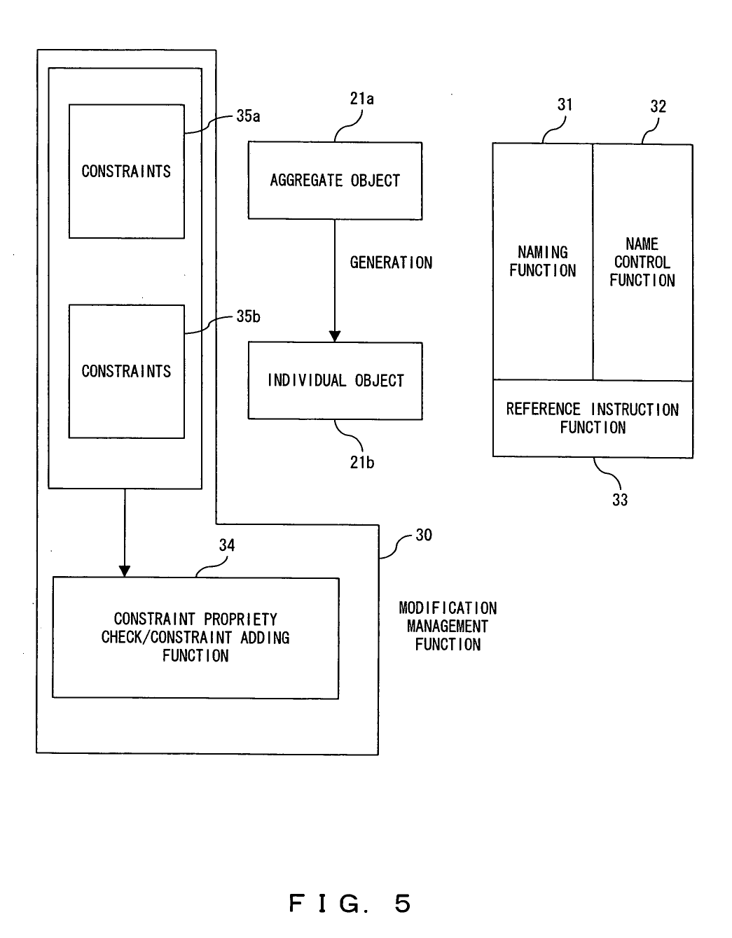

FIG. 5 is a block diagram showing the detailed configuration of a noun object management mechanism 14 shown in FIG. 2. In FIG. 5, a noun object management mechanism 14 comprises a modification management function 30, a name designation function 31, a name management mechanism 32 and a reference designation function 33. The noun object management mechanism 14 manages both an aggregate object 21a and an individual object 21b.

The modification management mechanism 30 is provided with constraints for each of the aggregate object 21a and individual object 21b, such as constraints 35a and 35b as an adjective modifying a noun object, and a constraint proprietary check/constraint adding function 34 determining the proprietary of these constraints and the like.

The name designation function 31 can enable a user or a system to give a name to, for example, an individual object 21b. The name management function 32 manages the names. The reference designation function 33, for example, distinguishes a specific individual object 21b from the other objects to enable its reference.

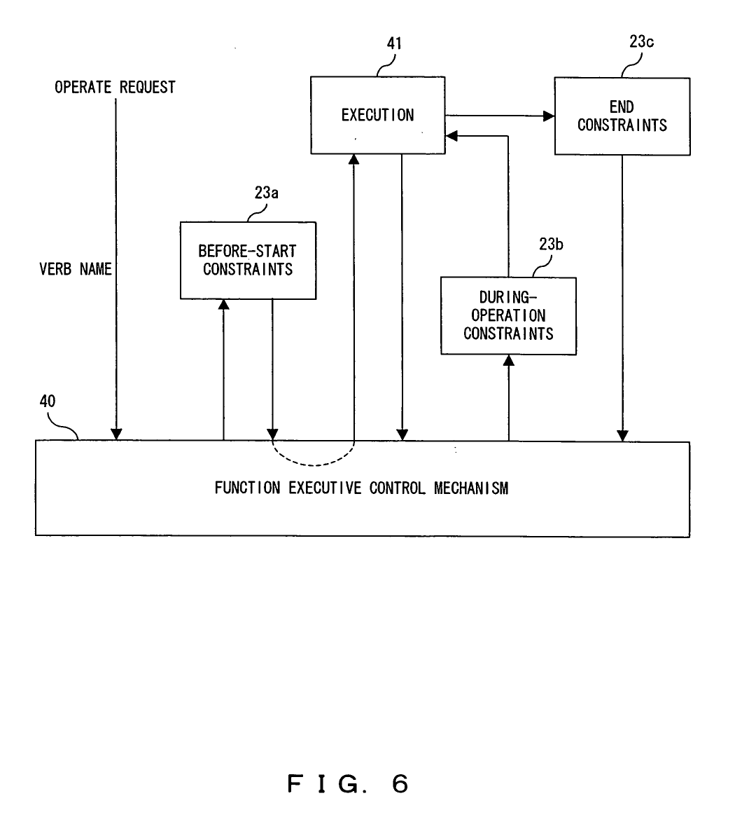

FIG. 6 explains the execution of a specific function corresponding to a verb object. In FIG. 6, the execution of a function is performed by a function execution mechanism 40, which is not shown in FIG. 2.

When specifically performing a function corresponding to a designated verb object, the function execution mechanism 40 controls specific function execution 41, based on the before-start constraints 23a, during-operation constraints 23b and end constraints 23c of the function execution. Specifically, the function execution mechanism 40 performs the specific function execution 41 after checking the before-start constraints 23a together with other constraints, checks the during-operation constraints 23b even during the function execution and further checks the end constraints 23c at the time of the end of the function execution.

For example, when drawing a circular arc, the coordinate values of at least three points must be determined. If only the coordinates of only two points are determined, it is impossible to draw a circular arc. However, the function execution mechanism 40 can also check in advance such constraints by checking the before-start constraint 23a, and can also automatically start a function that requires a user to input the coordinate values of three points, as requested.

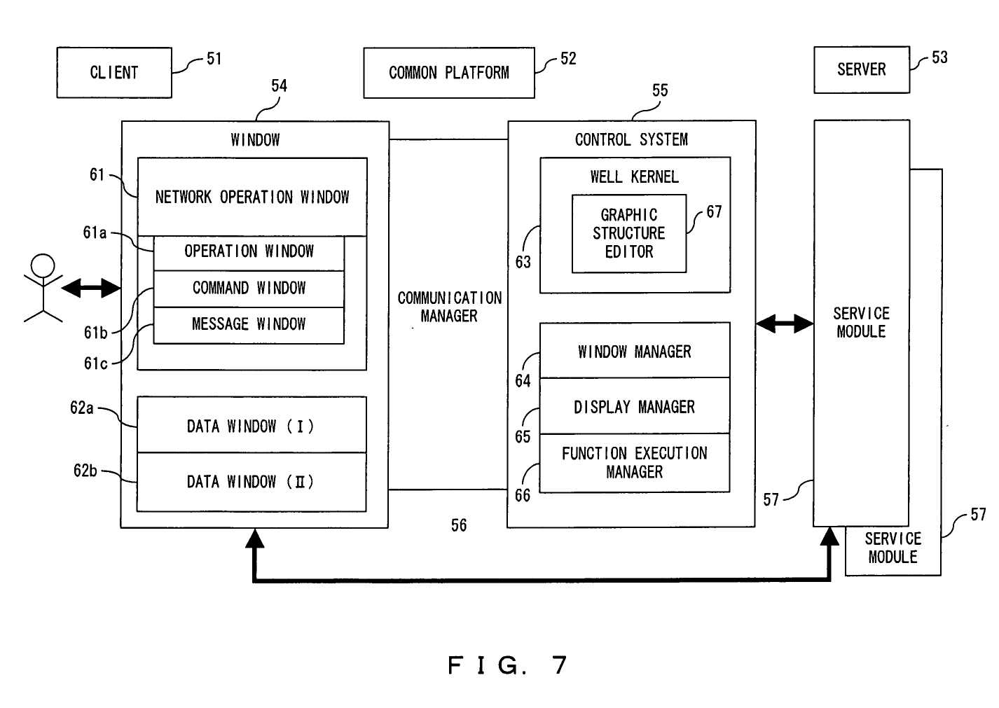

Next, the common platform is described. FIG. 7 is a block diagram showing the basic configuration of the data processing device with a common platform 52 as an interface between a client 51 as a user and a server 53 that executes a process designated by the client 51. In FIG. 7, the common platform 52 comprises a window 54 for data input/output to/from the client 51 and the like, a control system 55, and a communication manager 56 matching a data display format and the like between the window 54 and control system 55. It is assumed that a server 53 is generally composed of a plurality of service modules 57.

The window 54 comprises a network operation window 61 and a data window 62. The operation window 61a in the network operation window 61 displays pictures and characters such that, for example, enable the client 51 to designate a variety of operations. A command window 61b displays pictures and characters such that, for example, enable the client 51 to designate a variety of commands. A message window 61c, for example, displays messages issued to the client 51 by the system. A data window 62 also comprises a data window (I) 62a for displaying process results and a data window (II) 62b for displaying constraint data necessary for a process.

The communication manager 56 converts the display format of data exchanged between the client 51 and server 53 through the window 54, which is described later.

The control system 55 is, for example, a part of a WELL system, and comprises a WELL kernel 63 controlling a process corresponding to an object network, a window manager 64 controlling the selection of a variety of windows in the window 54 and the like, a display manager 65 controlling the data display on windows and the like, and a function execution manager 66 controlling the execution of a function corresponding to a verb object on the object network. The WELL kernel 63 further comprises a graphic structure editor 67 for regarding the object network as a kind of data and processing the graphic structure of a network.

If in FIG. 7, the client 51 designates a process target, the server 53 calls up an object network representing its process target area. Then, the graphic structure editor 67 stores the object network in the work area of the WELL kernel 63. Based on this stored result, the object network is displayed on the operation window 61a under the control of the window manager 64 and the like and through the agency of the communication manager 56.

Then, the client 51 specifies all or a part of nodes on the object network displayed on the window 61a and issues an instruction to the system. In response to this instruction, the communication manager 56 interprets the contents of the instruction and makes the server 53 call up a template corresponding to the designated noun object. This template is described later.

Then, for example, constraint data that exists in connection with a noun object is displayed on the data window (II) 62a. The client 51 selects the constraint data, the server 53 performs a process corresponding to the instruction of the client 51, and the result of the execution is displayed on the data window (I) 62a. The client 51 evaluates the execution result and issues a subsequent instruction.

On the window 54 of the data processing device using the common platform shown in FIG. 7, a data format most suitable for a user as the client 51 is used, and by converting the data format into a data format for a process in the data processing device in the common platform 52, the system becomes easy for the user to handle.

For a human being as the client 51, as the data display format, graphics, such as a graph, and a picture are easier to understand and easier to issue instructions than a text. In particular, as to a point and a line, it is preferable to issue instructions on the data window 62 directly or using a mouse.

However, as to a computer in the server 53, if a point is digitalized and expressed as coordinates of (x, y) and a line is expressed by listing up pixels located between a start point to an end point, process efficiency can be improved.

In other words, between the common platform 52 and client 51, it is preferable to be able to issue instructions to data indicating a point or a line while referring to it by expressing it as it is. Between the common platform 52 and server 53, it is preferable to be able to specify data in the index form and also to collectively transfer or combine a plurality of segments of data resulted by the instruction of the client.

Between the platform 52 and client 51, data indicating graphics and a picture are expressed as they are, and the client 51 can designate the data using the graphics and picture. Between the common platform 52 and server 53, data can be specified and expressed in the form of a list structure or a raster structure.

Between the common platform 52 and client 51, each data component can be designated by its name. Between the common platform and server 53, the data component can be specified by its name header.

In the preferred embodiment of the present invention, in the data processing device including the common platform 52 and server 53 shown in FIG. 7, a WELL system using a functional language called WELL, in which data and a process thereof are handled as objects and data is processed by an object network expressing them using a graph, is used.

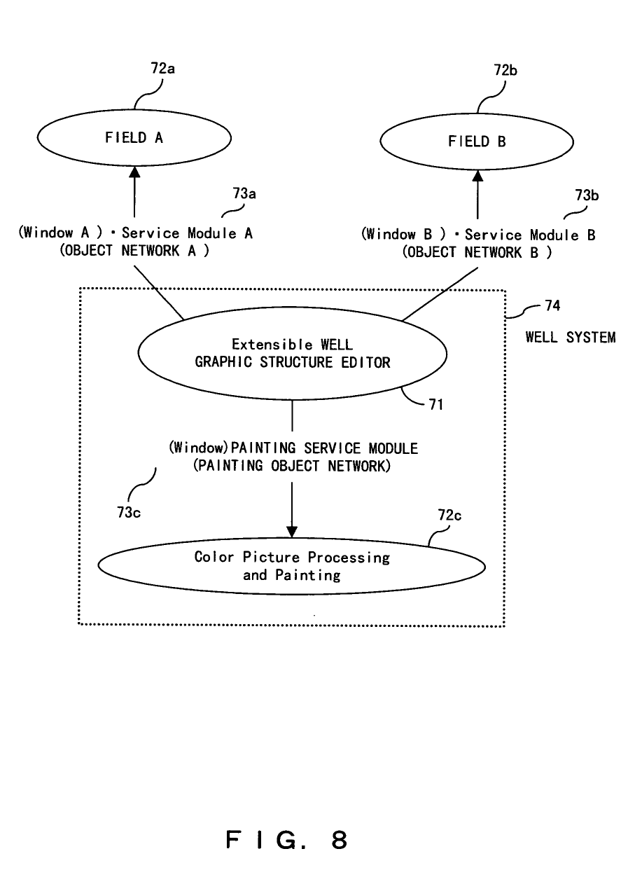

FIG. 8 explains the relationship between the WELL system and object network. In FIG. 8, reference numerals 72a, 72b and 72c are specific process fields, and in particular, 72c represents a color picture generation/coloring process field. Reference numerals 73a, 73 ad 73c are object networks corresponding to fields 72a, 72b and 72c, respectively, and in particular, 73c is a painting object network combined with a painting service module. The graphic structure editor 71 is the graphic structure editor of an extensible WELL system compatible with a variety of object networks.

If an object network corresponding to a specific field is supplied to this functional language called WELL, the object network can be processed without a program. This language is a window-oriented language, and by using a window as an interface with a client, a client-server model can be realized.

By combining a window required in connection with the color picture generation/coloring process field 72c with the object network 73c matching a service module performing a corresponding process, the WELL system becomes a WELL system 74 corresponding to the color picture generation/coloring process field 72c. Similarly, by combining the window with object networks 73a and 73b corresponding to other fields, WELL systems corresponding to fields 72a and 72b, respectively, can be generated.

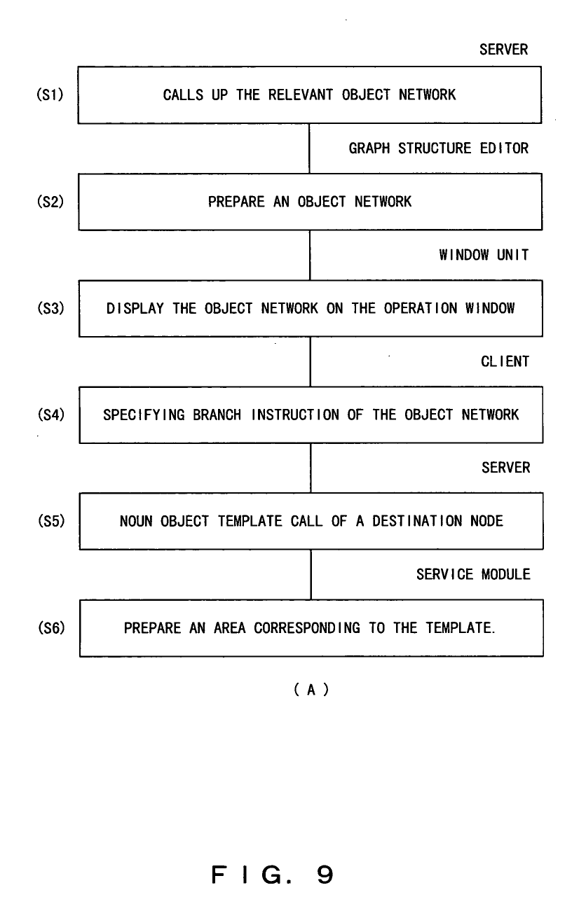

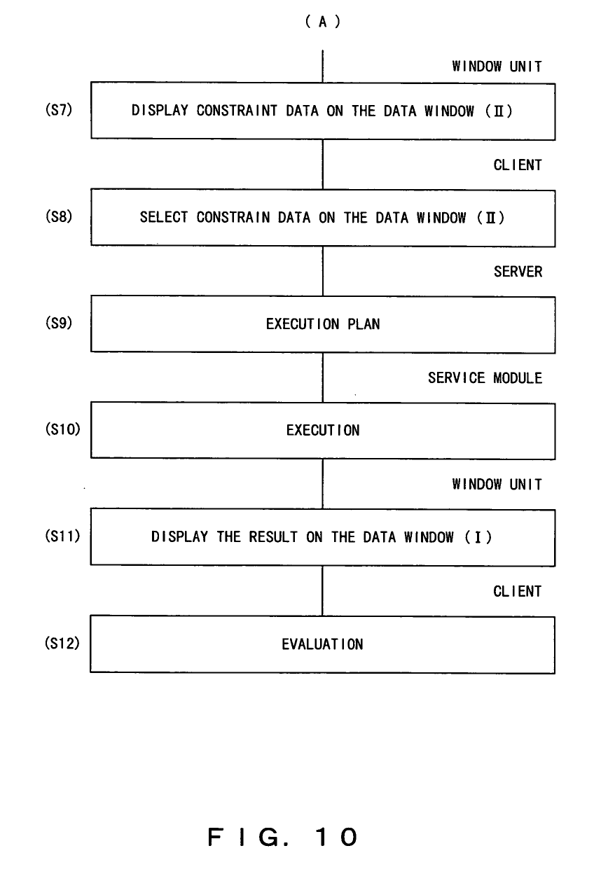

FIGS. 9 and 10 are flowcharts showing the data processing using an object network. When the process is started in FIG. 9, firstly in step S1, the relevant object network is called up by the server 53 shown in FIG. 7. For example, if a process is executed in a color picture generation/coloring process field, the object network shown in FIG. 4 is called up. In step S2, the graphic structure editor 67 stores the called object network in a work area on the WELL kernel 63. In step S3, the WELL kernel 63 starts both the window manager 64 and display manager 65, and the object network is displayed on the operation window 61a through the agency of the communication manager 56.

Then, in step S4, the client 51 designates a part of the displayed object network, for example, a branch and issues an instruction to the system. The communication manager 56 identifies this instruction. In step S5, the server 53 calls up the template of a noun object located on the tip of a destination node, that is, the branch. In step S6, the service module 57 prepares an area corresponding to the template.

Then, in step S7 of FIG. 10, the common platform 52 extracts constraint data corresponding to the template and displays it on the data window (II) 62b. In step S8, the client 51 selects specific constraint data from the displayed constraint data, and the communication manager 56 identifies the result of the selection. Then, the result is transmitted to the server 53 through the agency of the WELL kernel 63. In step S9, an execution plan is generated.

In step S10, according to the generated execution plan, the service module 67 executes a process designated by a user, such as drawing a line, coloring or the like. In step S11, the result is displayed on the data window (I) 62a. Then, in step S12, the client 51 evaluates the process result and issues a subsequent instruction.

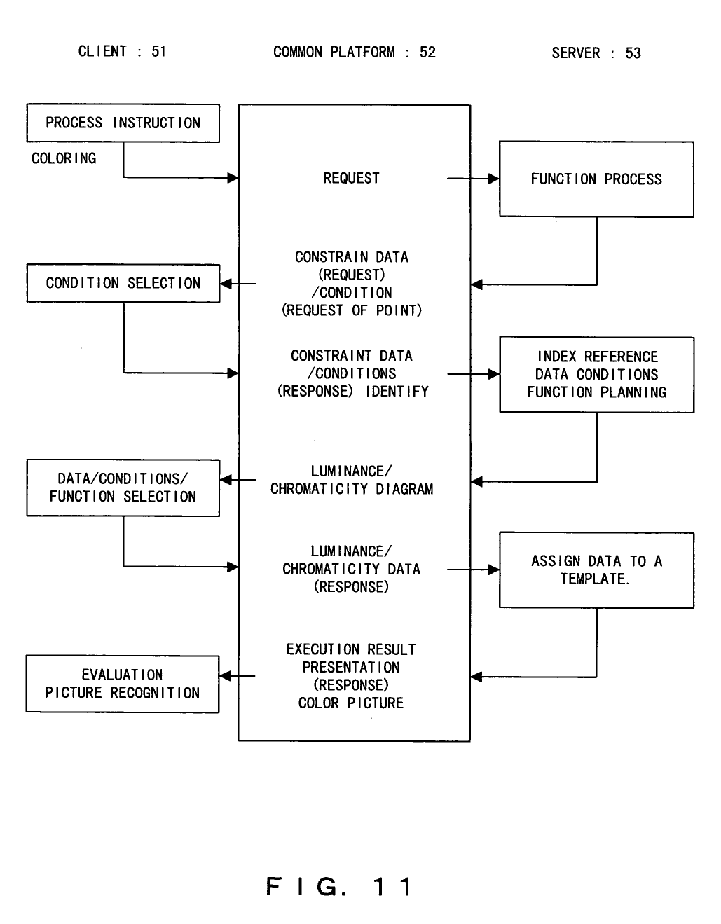

FIG. 11 shows a color picture generation/coloring process method in the data processing device provided with the common platform. Here, the generation process of the “luminance on the point”, that is, giving luminance to points on the attribute network on the right side of the object network explained with reference to FIG. 4 is described.

Firstly, if the client 51 issues a request to generate “luminance on the point”, to the server 53 through the common platform 52 as a process instruction, the server 53 issues a request for information about a point to which luminance is given as constraint data/conditions needed to plan an execution function. Then, the client 51 identifies a point as condition selection. The server 53 recognizes the point by referring to the index of a template, which is described later, and requests the client 51 to select luminance data to be put on the point as data needed to plan function execution.

This request is issued to the client 51 as a luminance/chromaticity diagram. Then, the client 51 transmits luminance/chromaticity data to be put on the point on the luminance/chromaticity diagram as data/conditions/function selection. Then, the server 53 assigns the data to the template and executes the process. Then, the server 53 submits a color picture as the execution result to the client 51 through the common platform 52. Then, the client 51 evaluates the execution result by picture recognition and moves to designate a subsequent process.

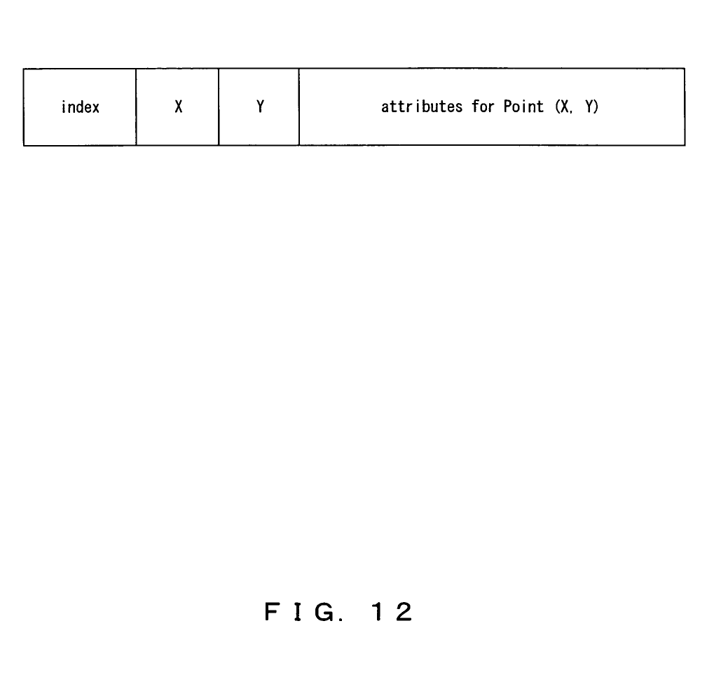

FIG. 12 shows an example of a template used in the process of the server 53. For example, this template corresponds to a noun object of the point shown in FIG. 4, and stores the coordinates (X, Y) of the point on the display screen, an index used to specify the point on the system without using coordinates and the attribute data of the point, such as luminance, chromaticity and the like.

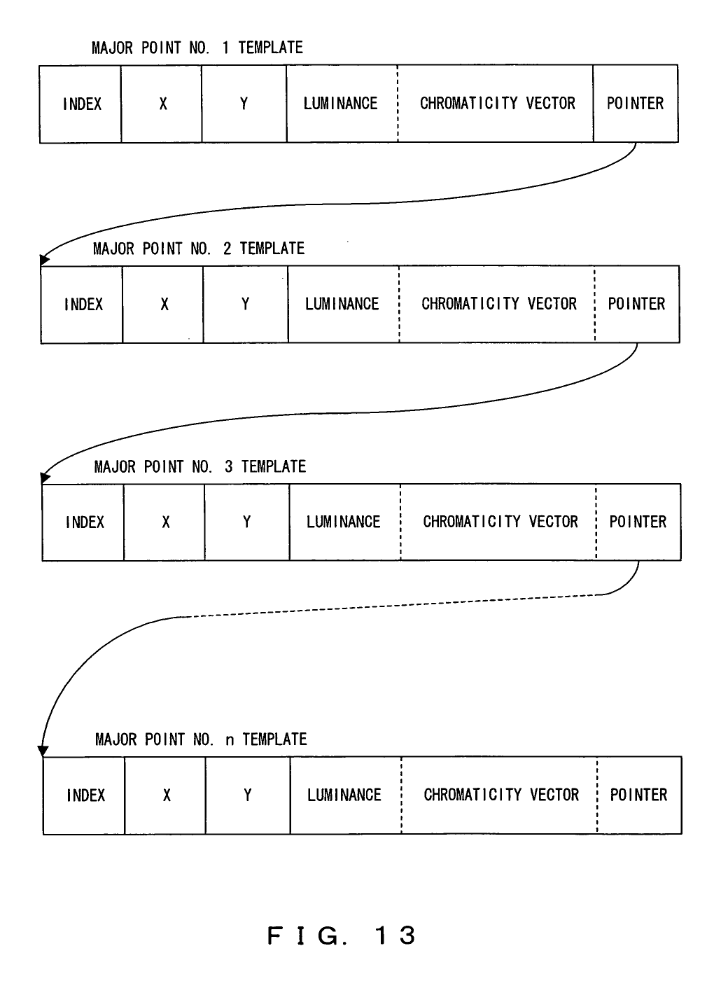

FIG. 13 shows an example of a template corresponding to the noun object of the line segment shown in FIG. 4. The line segment template stores a pointer pointing to another point in the attribute data storage area on the template, of each of the major points No. 1, No. 2, . . . , No. n constituting the line segment in addition to the luminance and chromaticity vector of each point, and it is defined that the entire template corresponds to one line segment, by these pointers.

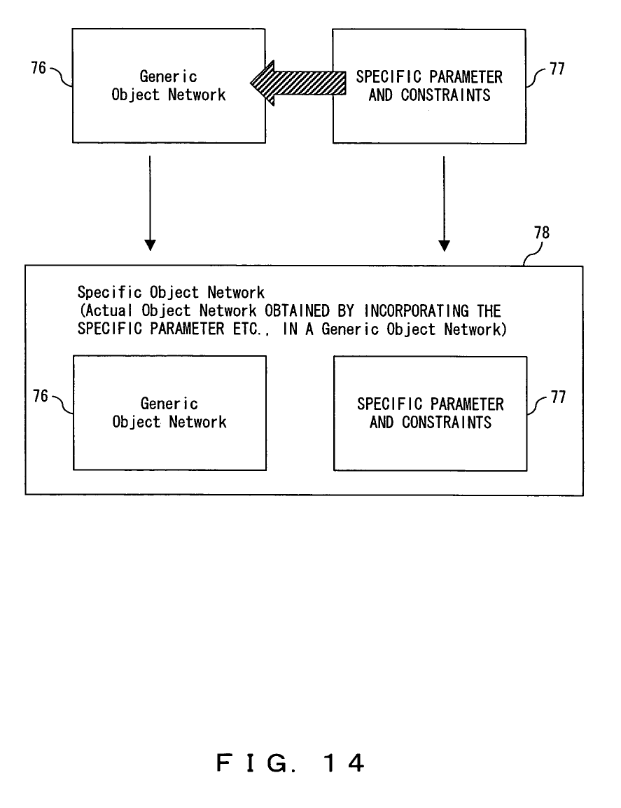

FIG. 14 shows how to generate a specific object network as a specific object network for a specific process, from a generic object network. For example, as a formula obtained by generalizing variables is prepared in mathematics, a generic object network 76 obtained by generalizing parameters and constraints is prepared. Then, by integrating parameters and constraints 77 for a specific process into the generic object network 76, a specific object network 78 for a specific process can be generated.

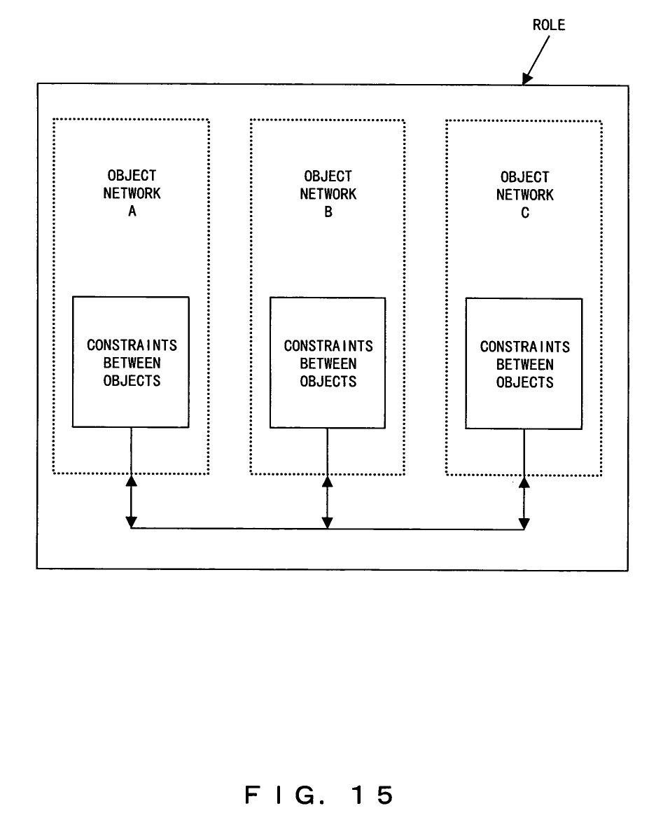

Next, the role function and interactive function of the data processing device using the object network and common platform are described. FIG. 15 explains the definition of a role. As shown in FIG. 15, a role is defined to be a component of the object network, and functions as an execution unit. A name is given to each role, and the role is referenced by the name inside and outside the system.

The relationship among a plurality of object networks in one role corresponds to a constraint defined against an object constituting each object network, and is specified as a relation among the attribute values of an object. A role can also be made of only one object network.

In the data processing device of this preferred embodiment, for example, in order to satisfy an instruction from a user by a plurality of roles comprehensively performing processes, a cooperative operation among roles is necessary. For that purpose, the interactive function must be enriched among the roles and free communication must be provided. In order to satisfy a request from a user, an efficient interactive function must be provided between a user (can be considered to be one of support roles) and a system for providing services. As described earlier, an interface function between a user and the system can be realized by the common platform.

As the components of an efficient interactive function between a user and the system or between a plurality of roles in such a data processing device, event drive and data drive are used.

Firstly, as the event drive, for example, a client requests the system to realize a noun object on the common platform. On the system side, upon receipt of the request from the common platform, the server returns the result of the execution to the client as a response.

As the data drive, for example, when a value corresponding to a specific attribute is not defined in a template corresponding to a noun object currently handled in the system, the system requests a client to set its attribute value. At the time of this request, the fact that no attribute value is defined is displayed on the data window, and the client is requested to define a necessary attribute value on this data window.

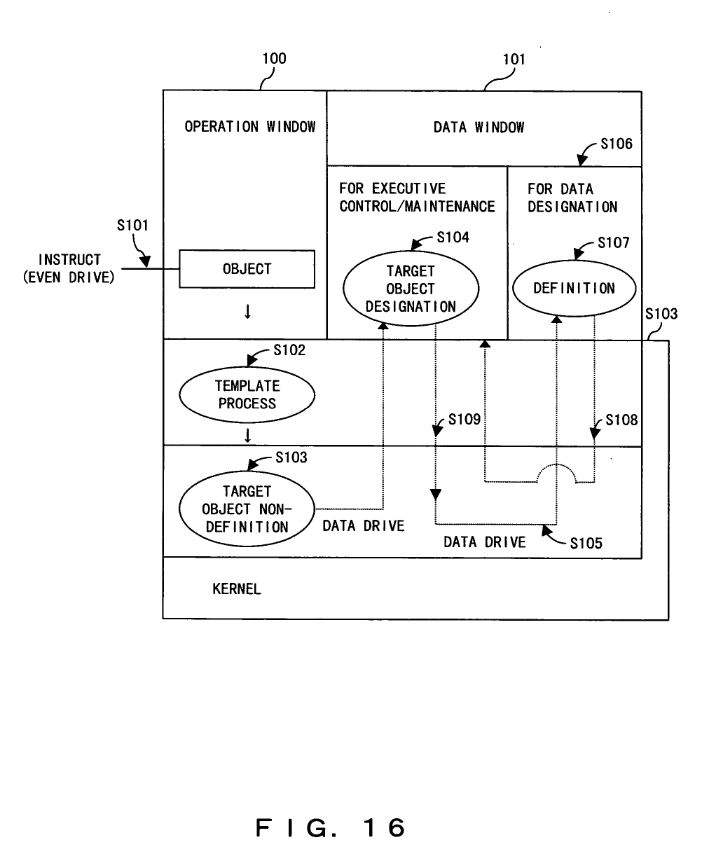

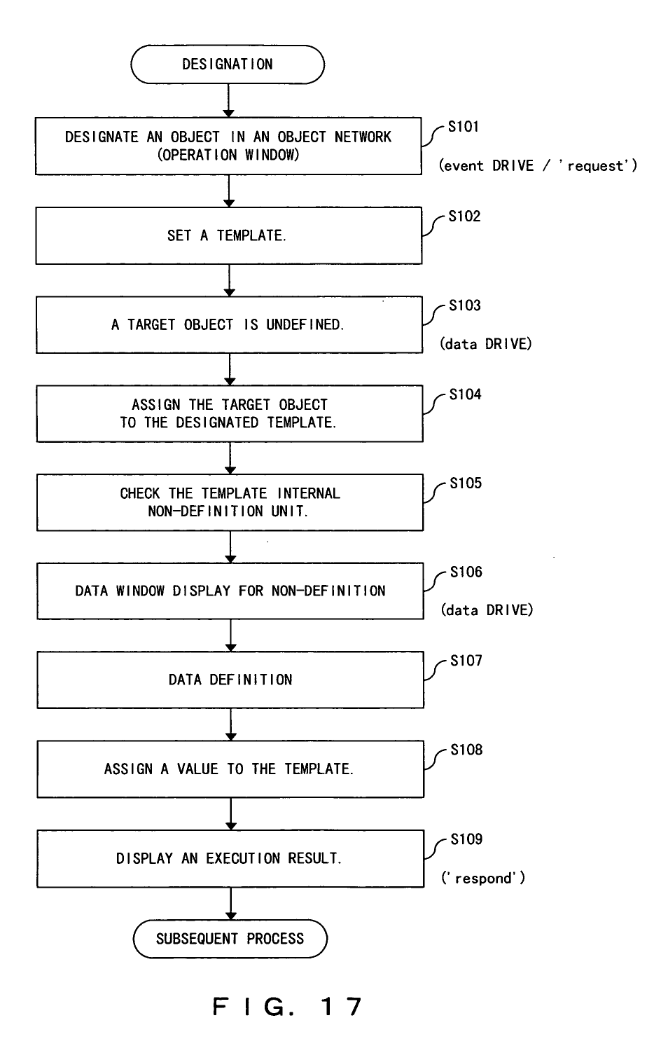

FIG. 16 shows a process flow inside the WELL system in order to explain the interactive function based on such event drive and data drive. FIG. 17 is a flowchart showing the process of the interactive function based on the event drive and data drive in correspondence with FIG. 16. A process based on the event drive and data drive is described with reference to FIGS. 16 and 17.

Firstly, in step S101 of FIG. 17, a client, such as a user, designates, for example, one object on an object network displayed on the operation window 100 of the common platform shown in FIG. 16, as a request for the system. This corresponds to event drive (request). In response to this user's designation, in step S102, a template corresponding to the object is set.

In this case, if the specific name of a target object corresponding to the set template or the like is not defined, the kernel 103 of the WELL system determines the fact, and in step S103, the client is requested to designate the target object as data drive. For example, the case where the name of an object on a specific object network corresponding to an object composing the generic object network described with reference to FIG. 14 is not defined corresponds to this.

The client designates a target object on the data window 101. In step S14, this target object is assigned to a template. Furthermore, in step S105, the kernel 103 checks whether there is an undefined attribute value in the template. If there is an undefined attribute value, in step S106, a request to input the undefined attribute value is displayed on the data window as data drive in order to request the client to define the value.

The client defines the undefined attribute value on the data window 101. In step S107, this data definition is received by the system. In step S108, the attribute value is assigned to the template, and the WELL system executes a process using the contents of the template to which the attribute value is assigned. In step S109, the WELL system displays the result of the process on the data window, and terminates a process (response) according to the client's instruction.

As described above, a user-friendly and efficient interface can be realized between a user and the system by the interactive function based on event drive and data drive. A communicative function to support a cooperative operation among role functions can also be realized among a plurality of roles. By realizing an interactive function using the kernel of the WELL system, the present invention can be applied to a variety of systems, in particular, software architecture in which a personal computer is taken into consideration.

If a cooperative operation is made among a plurality of roles, it is preferable to provide an interactive function between a leading role playing the role of a person in charge and a support role providing a service function in order to support the leading role, based on common data. The leading role must operate in a specific environment related to the leading role and always monitor environmental data related to this environment. If the support role shares the environmental data with the leading role, and when the environmental data changes, the features of the change can be notified to the leading role by offering, the leading role can match the change of the environment and operate accordingly.

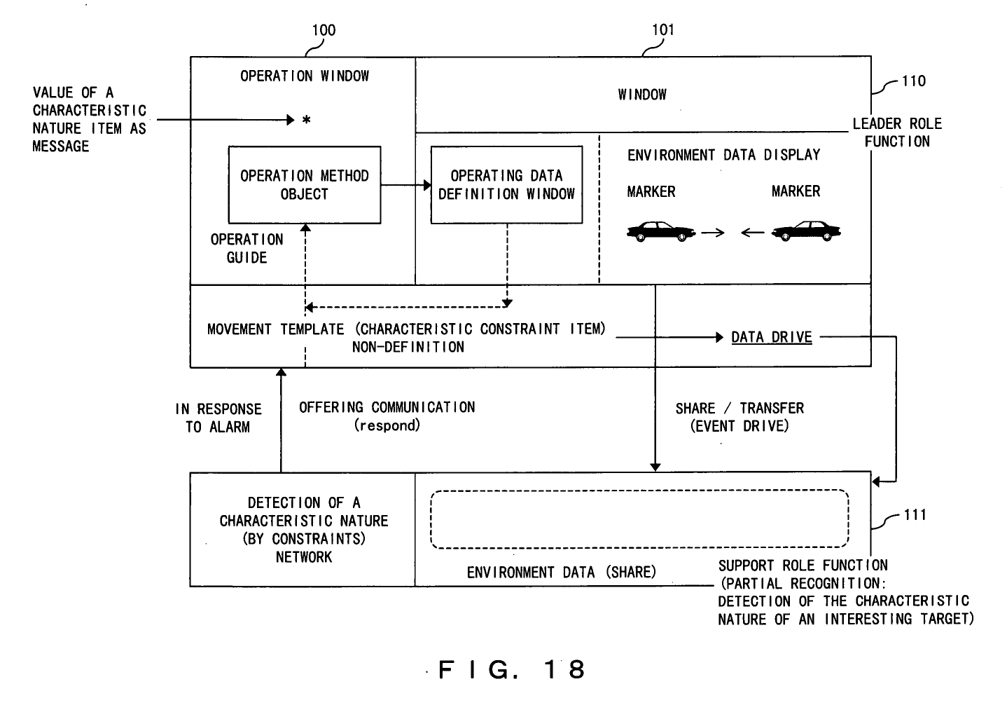

FIG. 18 explains the interactive function between a leading role function and a support role function based on environmental data. In FIG. 18, the semi-automatic driving of two automobiles is examined as an example. In this case, the system is built in each automobile, and the two automobiles run in a course where there is a possibility that the automobiles may collide with each other.

The leading role 110 built in one of the automobiles is provided with an object of how to drive a semi-automatic automobile, and this object is displayed on the operation window 100 of the common platform. The data window 101 displays environmental data.

If the displayed environmental data changes, this change is transferred to a support role 111 as event drive. The support role 111 detects the characteristic nature of the environmental data by a characteristic-nature-detection object network provided for the support role.

For example, when a characteristic nature that two automobiles approach too close to each other to avoid collision if no action is taken, the support role 111 notifies the leading role 110 of the fact by offering, in other words, responds to it. In response to this offering, the leading role 110 sets a movement template according to the driving method object.

If there is an undefined part in the contents of this movement template, for example, data on how much the automobile should be moved in what direction is not defined, the setting of the undefined data is requested by data drive. If an automobile is not semi-automatically driven, a user, that is, a driver is requested to set the undefined data. However, in this case, since the automobile is semi-automatically driven, for the example, the support role 111 is requested to do so. The support role 111 detects a necessary characteristic nature from the environmental data, and supplies requested data according to the result of the detection. When this data is assigned to the movement template, the leading role starts the interactive function with the user using the driving method object as a drive guide in order for the user to be able to actually drive accordingly.

So far the object network and common platform have been described. Next, data processing for realizing an intention is described.

An intention targeted in this preferred embodiment is not a partial and fairly small instruction such as setting points or generating point sequence on the screen, as described with reference to FIG. 4, but a fairly large intention, such as the intention of a user, that is, a driver that semi-automatically drives an automobile while avoiding the collision of two automobiles, as described with reference to FIG. 18.

This intention includes three types of intentions; a common intention, a contrary intention and an independent intention. Firstly, the common intention is an intention shared by each user, that is, client of two systems, such as one shared by the driver of each semi-automatically driven automobile, to avoid collision.

The contrary intentions are generated between the respective users of two systems, to the contrary to each other, such as one in the case where a bird flying in the air wants to eat a fish swimming in the sea when finding it while the fish wants to escape from it. When a gorilla is playing with an owl, the gorilla learns to how to tease the owl in correspondence with the owl's movement without wounding the owl while the owl learns to how to escape it from their reciprocal movements, it is considered that there are contrary intentions against each other. In this case, the gorilla's aim is not to catch or kill the owl, but is to stop the action one step before and restore the original status. This can be realized by the support role function of the gorilla detecting that the reaction of the owl as a feature constraint comes to the utmost.

Unlike the common intention and contrary intention, the independent intention is in particular, one had by the user of another system, for example, regardless of the intention of another human being, when attempting to act with a specific purpose, such as had by a human being when painting as described earlier, or generating a moving picture by integrating a plurality of segments of multimedia information.

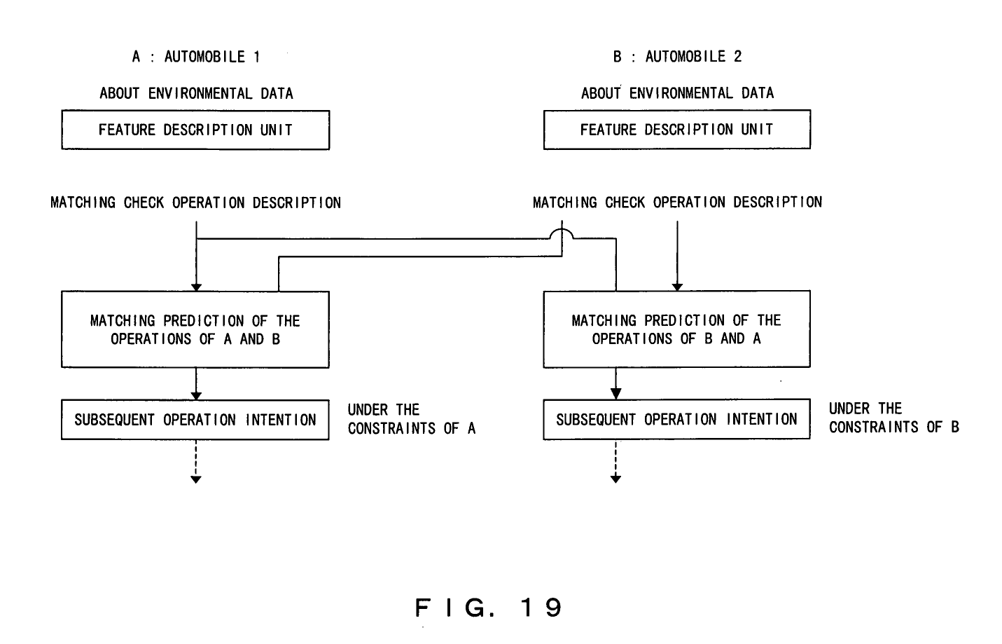

FIG. 19 explains an example of the matching prediction process in the case where users A and B have a common intention to semi-automatically drive their respective automobiles while avoiding collision. In FIG. 19, each of users A and B predicts the operation of the opposite automobile based on the resulted feature description of each environmental data, and executes a matching operation as a subsequent operation in order to avoid collision specified by constraints.

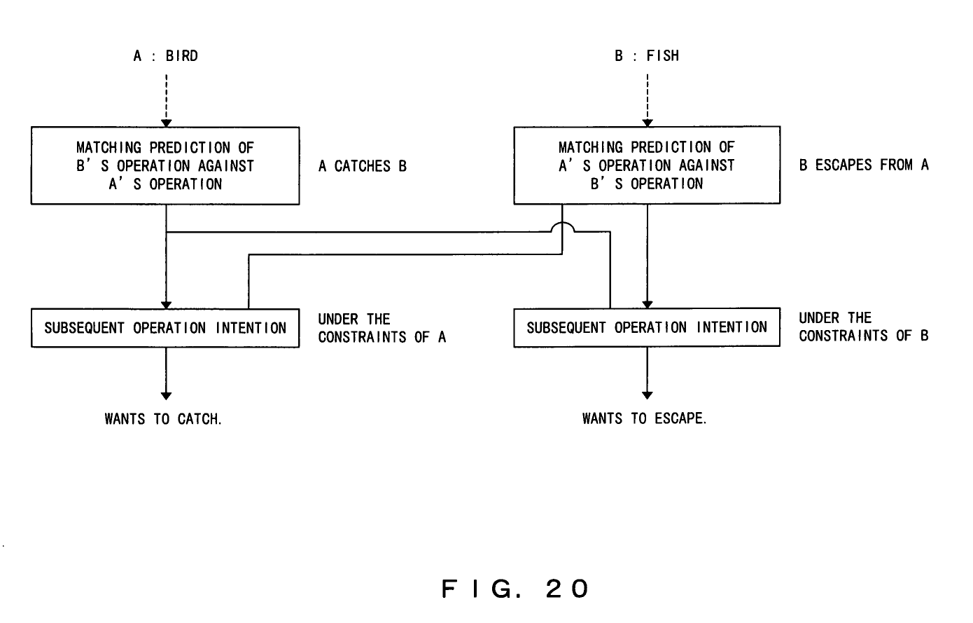

FIG. 20 explains the matching/non-matching prediction process in the case where each of two users, that is, clients has a contrary intention against each other, as in the above-mentioned case of a bird and a fish. In FIG. 20, the bird attempts to catch the fish and the fish attempts to escape from the bird. Therefore, the bird predicts a route taken by the fish and the fish in turn predicts the approaching route of the bird. Thus, each of the bird's and fish's moves are to evade the prediction of the opposite party. However, in this case, their respective movements are made under their respective constraints. Therefore, the bird moves with a purpose of catching the fish, and the fish moves with a purpose of escaping from the bird.

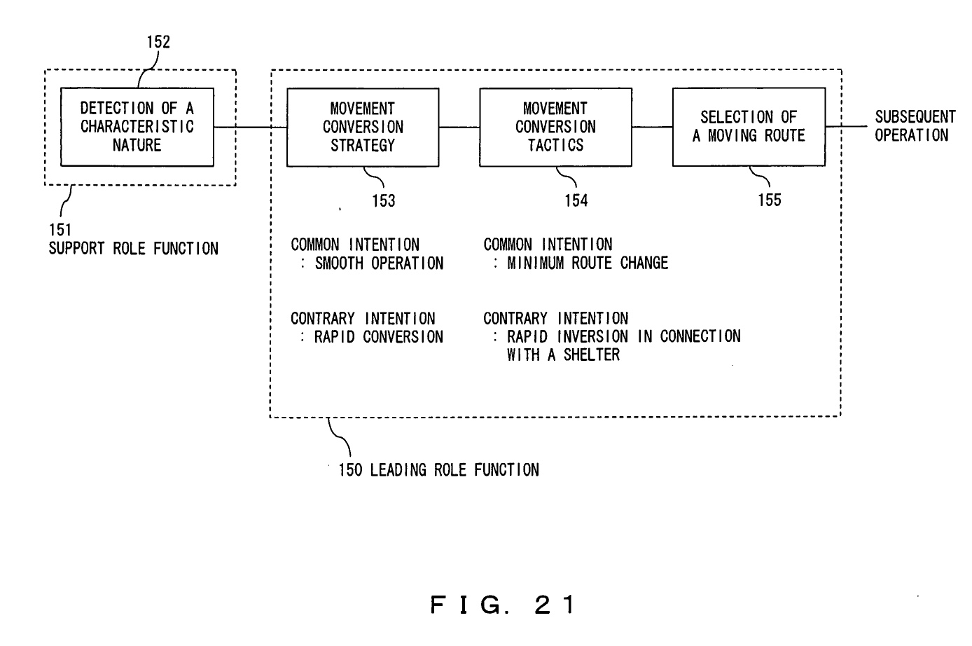

In the intention realizing data processing, for example, in order to prevent two automobiles from colliding with each other, it is very important to determine a strategy and tactics on what movement should be made next, based on the characteristic natures, that is, under constraints, such as road situations. FIG. 21 explains the movement conversion as a subsequent movement, by a strategy and tactics for the common intention to avoid the collision of two automobiles and contrary intentions between the bird and fish.

In FIG. 21, the determination of a subsequent operation by a strategy and tactics is made by a leading role function 150 playing a leading role, and the detection of characteristic natures, such as environmental data and the like, is conducted by a support role function 151 playing a support role. Firstly, the detection 152 of characteristic natures, such as road situations, the speed of the opposite automobile and the like, is conducted by the support role function 151, and the result is supplied to the leading role function 150. The leading role function 150 firstly determines a movement conversion strategy 153. In the case of a common intention to avoid the collision of two automobiles, to maintain the operation as smooth as possible in the movement conversion is the strategy 153. In the case of contrary intentions for a bird to catch a fish, in order to evade the prediction of the opposite party, rapid movement conversion is adopted as the strategy.

Then, the leading role function 150 determines movement conversion tactics 154. In the case of the common intention, for example, tactics for minimizing a route modification is taken in order to avoid shock given to passengers and the like, as much as possible. In the case of the contrary intention, for example, tactics for making a rapid turn in connection with a shelter is taken in order for the fish to hide itself behind the shelter, such as a rock or the like. The selection of a movement route 155 is made according to such tactics, and a subsequent operation is determined.

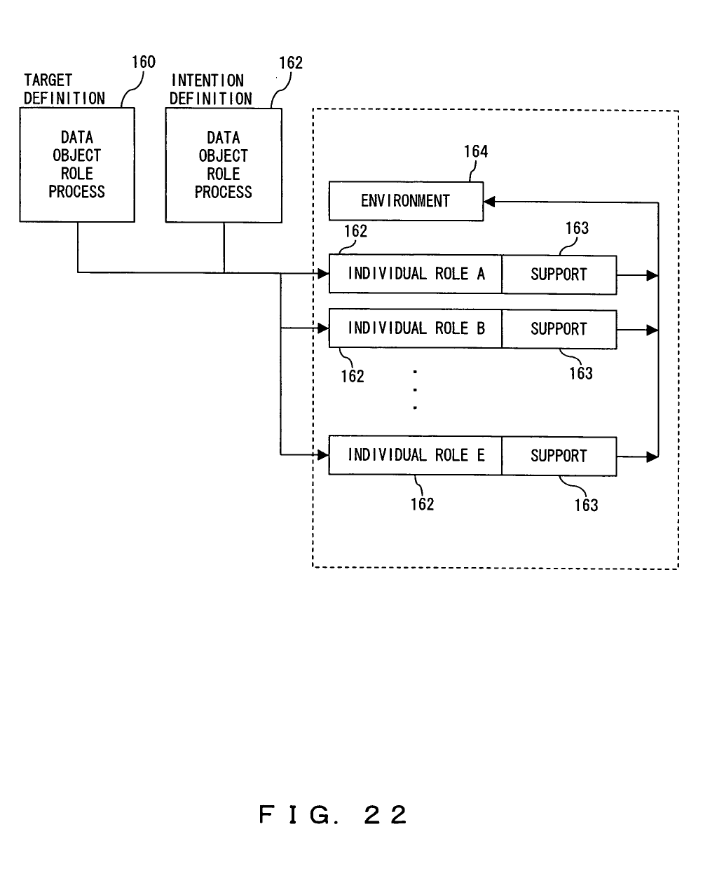

FIG. 22 is a block diagram showing the summary of the entire structure of an intention realizing data processing method. In FIG. 22, firstly target definition 160 and intention definition 161 are made. The target of the target definition 160 is, for example, two automobiles running facing each other, and the contents of the intention definition 161 is for the two automobiles to semi-automatically drive while avoiding collision. Each definition is made using a data model provided in the form of a template or the like, which is described later, an object model provided in the form of an object network, a role model indicated as an aggregate of a plurality of object networks as described with reference to FIG. 15, and a process model meaning a lot of integrated roles performing a cooperative process.

According to the contents of these target definition 160 and intention definition 161, an intention realizing process is performed by a plurality of individual roles 162 and support roles 163 supporting each individual role. However, in this case, for example, each support role 163 monitors environment 164, detects characteristic natures and supplies them as constraint data for the individual roles 162.

Next, the hierarchical structure of an object in this preferred embodiment is described. In this preferred embodiment, the hierarchical structure of an object is composed of four models of a data model, an object model, a role model and a process model.

As to the data model located in the lowest order of the hierarchical structure, its attribute structure is planned, for example, as the template shown in FIG. 12, and is inputted to the kernel of the WELL system. The input is made in the form of a list of data. The kernel sets a process request in a work area for service execution in connection with event drive in the course of process execution, and designates a cell position needing data definition in the template by data drive.

The object model located in the second lowest order is classified into three groups of a form model, a feature model and an object network model. Firstly, the form model expresses patterns of a noun object and a verb object in a specific form, such as a “point” shown in FIG. 4.

As a noun model, a common noun, a proper noun or a generic noun obtained by aggregating and abstracting common nouns, can be used. In an object network, a common noun is usually used as a name, an expert applies list structure expression to a template in the data model and the name is stored in the WELL kernel. In this stage, a common noun has the attribute of the infinite article “a”. When the common noun is designated by event drive, for example, from a user, preparatory work for data definition is performed, and the common noun is converted into a proper noun with the attribute of the definite article “the”.

The verb object as a form model is paired with a noun object, and, for example, their relationship becomes that of the subject and the predicate. Verb service execution preparation and service execution operation are performed in the course of the execution of an object network as a job.

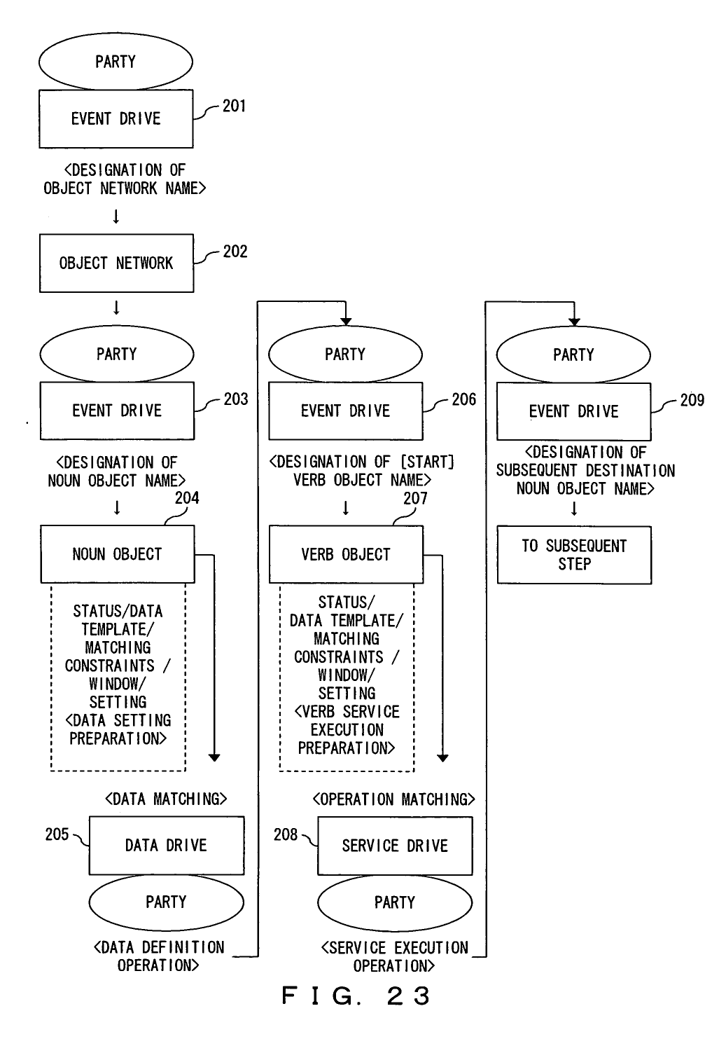

FIG. 23 explains the user process of an object network 202. In FIG. 23, a party as a user designates the name of an object network by event drive 201. Then, the party further designates the name of a noun object 204 on the object network 202 by even drive 203.

The data matching of the designated noun object 204 is checked by the system. If there is undefined data, the relevant party is requested to define the data.

When the undefined data is defined by the party and the name of a verb object 207 is designated by event drive 206, for example from a user, an instruction to point to the object in order to start the process is issued to the system. The system checks the operational matching of this instruction, and applies service drive 208 for providing a necessary service as event drive to a party that executes the service. Thus, a service can be executed by the party.

Then, a party, such as a user, designates the name of a noun object to become a subsequent destination, by event drive 209, and a process in a subsequent step is continued.

The feature model of the object model expresses features, such as “colored points” constituting a painting object network or the like, based on the attribute value of a noun object and constraints according to the environment are attached to it.

For example, when the WELL kernel requests another server, such as a specific role server performing a specific detailed process, to execute a service related to a position of the template structure of an object where the contents of matching constraint items, by event drive, data drive requests the server to supply data specifying the feature model. This process corresponds to communication between a plurality of servers, and is one of the jobs of the WELL kernel.

Then, the object network is stored in a work area managed by the WELL kernel, as a graphic structure having the respective names of noun and verb objects formed in a template as a data model, as a node and a branch, respectively, and is displayed on the common platform. For that purpose, an expert must express the noun and verb objects expressed in the form of a form model or a feature model in the form of specification, and prepare them as graphic structures for their execution. Therefore, a graphic structure editor needed to describe graphic structures and to display them on the common platform becomes necessary as a tool.

If an object is an abstract noun, both an object network and an aggregate of data to be supplied to the object network are needed to embody its abstract nature. For this purpose, a mechanism related to a process model, which is described later, is needed. The object network model has the name of the network as its header, and can be referenced by the name. Alternatively, the object network model can be referenced by having a function to search for a noun object and a verb object as components.

The third model composing the hierarchical structure of an object is a role model. The role model corresponds to the role function described with reference to FIG. 18, and expresses contents to be executed by a party in the environment, as an aggregate of a plurality of object networks.

Therefore, each role model has its own name, and can be referenced by the name. A matching constraint item name can also be added and can be referenced by retrieving using the item name. The role also has a hierarchical structure and can be referenced one after another.

The concept of a role is to express facts/contents to be executed by each party, and is related to the environment surrounding the party. Therefore, the contents to be executed vary as the environment changes. In other words, the structure of an object network and the like must be adaptively changed according to the environment.

For this purpose, matching constraint items are used. The contents of the matching constraint items are described as the contents of the cell of a template defined as a data model corresponding to a noun object or a verb object on an object network. As shown in FIG. 23, the contents of an noun object and a verb object are defined on the object network as respective attribute items related to data definition preparatory work and verb service execution preparatory job, respectively, and are processed by a party, such as a user, using a driving method corresponding to the job name.

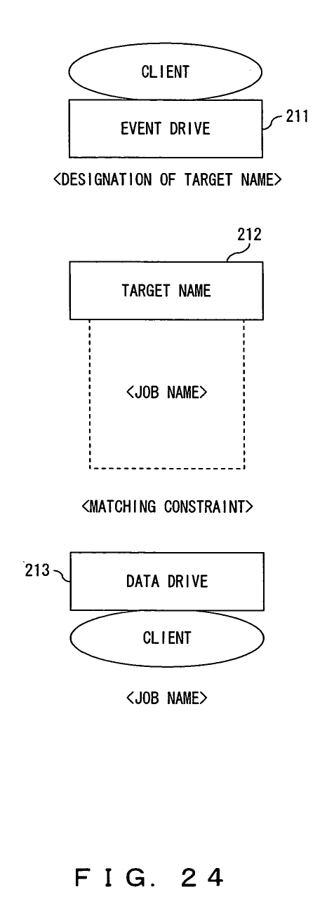

FIG. 24 explains the relationship between a party related to matching constraints and a driving system. In FIG. 24, a party designates the name of, for example, a noun object as a target name and instructs the WELL system to execute it as event drive 211. The WELL kernel verifies matching constraints by processing a job with a job name related to a matter described in the template of the object with the designated target name 202, and instructs the relevant party to do the job with the job name, by data drive 213 through the common platform according to the result.

For example, matching constraints that are defined by an expert and are built in an object are related to the matching constraint items of another object as the process result of a support role function to recognize the constraint feature items of environmental data, and is used for a joint operation with a subsequent object network to be executed.

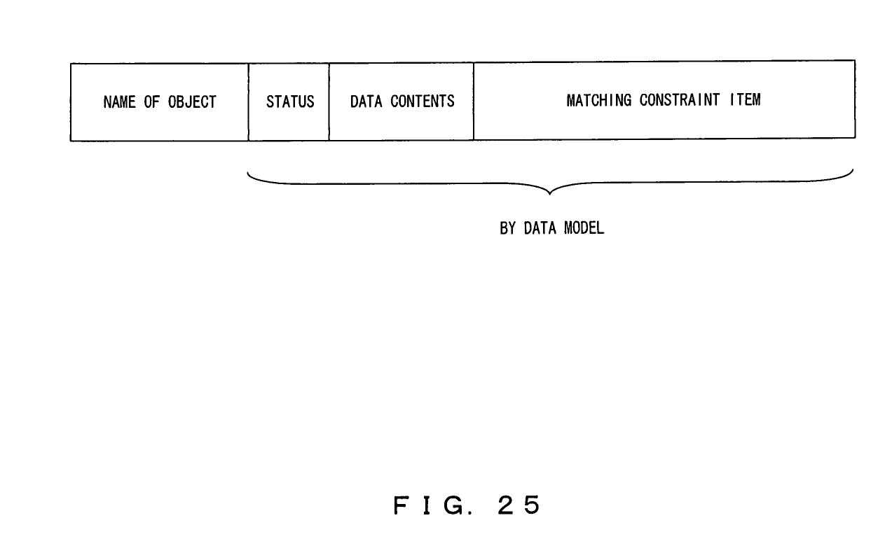

As described earlier, the object network is defined by a graphic structure composed of a noun object as a node and a verb objected as a branch. FIG. 25 explains the template of an object. As the cell contents of a template, four items of a name, status display, data contents and a matching constraint item are defined. As to a generic object, a link with a hierarchical structure is formed by having an object name as a parameter for embodying data contents. A hierarchical parameter is embodied using the matching constraint item one after another.

The basic data contents of a noun object include a numerical value, a symbol, etc., as specific original data, an abstract name, such as the name of an object as the parameter for embodying and the like.

A function name is the most specific as the data contents of a verb object. In that case, the function name must be able to be referenced as an executable algorithm.

As to a function, there is a conversion process from an abstract one to a concrete one in it like the contents of a noun object, and its structure is digitized. This structure is generally implemented in an agent role server intermediating between a client and a specific role server so that the specific role server can conduct the conversion. Alternatively, this structure is digitized by event drive so that a request can be executed.

The fourth model in the hierarchical structure of an object is a process model. This model defines a process as a dynamic process to be executed by a plurality of role models. When planning and drafting a process, the execution of a process by a plurality of role functions is planned against matching constraint items defined in a verb object in the plurality of role functions. As this control method, control according to time and phase constraints, such as a continuous process, a simultaneous process, a stoppage process, a re-start process or the like, is used.

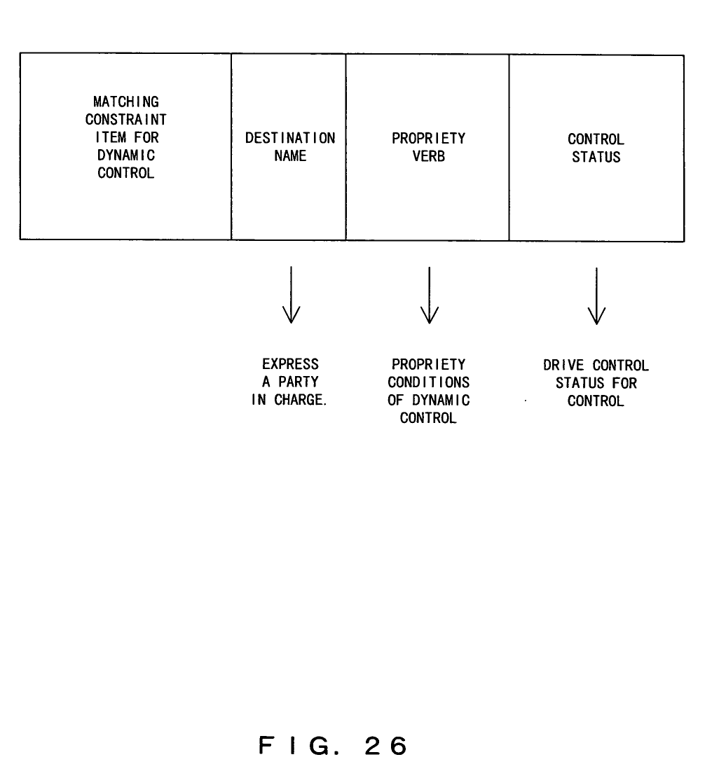

FIG. 26 shows the contents of such a template for dynamically controlling a verb object. FIG. 26 shows the detailed cell contents of the matching constraint item shown in FIG. 25. In FIG. 26, a destination name means a party in charge. A propriety verb is paired with a noun object as the subject, and indicates the propriety conditions of the dynamic control of a verb object to be dynamically selected. A control status controls the service executability of a party according to the current status of the party in response to a process request to the party.

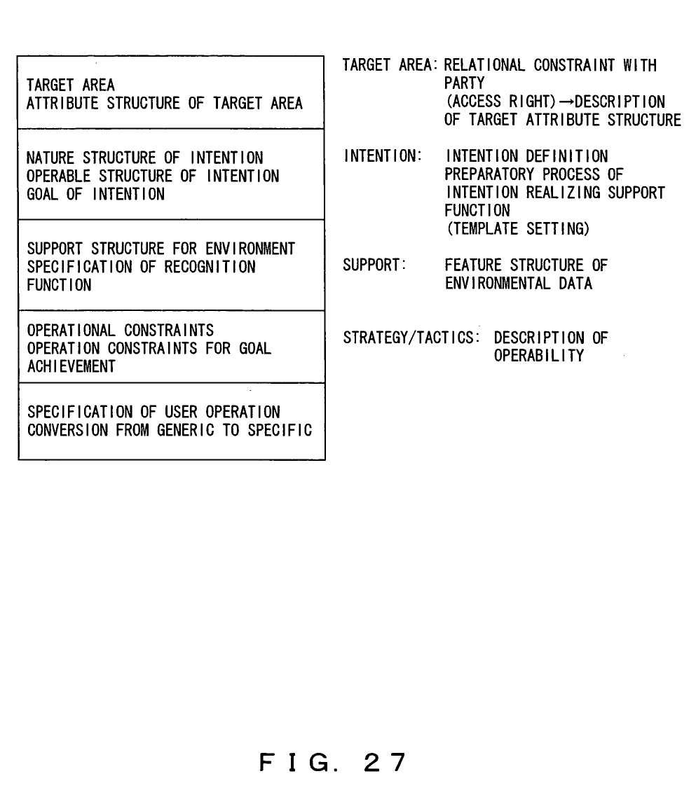

Next, the intention expression process is described in more detail. FIG. 27 shows the definition structure of an intention. Firstly, as the first step, both a target (or object) area name and the attribute structure of the target area are defined. In the case of the above-mentioned two automobiles, the target area is facing traffic, and the attribute structure of the target area is data, such as whether the road is a priority one, which the road has, a single lane or two lanes, or the like.

In this first step, whether the party is qualified to realize an intention related to the target area is checked, and the propriety of the attribute data related to the target area of the party is checked by interaction with the system. For example, in order for a party to realize an intention to drive an automobile on a specific road, the party must be qualified to safely drive an automobile, and this is one access right to use the road. This is an access right to enable a plurality of drivers to drive their automobiles without any accident in a social system.

In order to conduct Internet communication, a party must have an authorized terminal and a communication line, and a specific access is permitted by interaction with the system using data including encryption words used to authenticate the party, such as an account, a password and the like.

Specifically, the system starts the process of an object network corresponding to a “job name” when the party plans to realize the intention with regard to the target area and <designation of target name> is performed as shown in FIG. 24. At this moment, the “matching constraints” attached to the object corresponding to the “job name” is verified.

In the intention definition structure shown in FIG. 27, following the definition of a target area, a generic intention corresponding to a generic object network is converted into a specific intention corresponding to a specific object network one after another. By determining the propriety of conditions described in matching constraint items attached to a generic or specific noun object in the flow, the system requests a party to perform a “data drive” operation, and necessary data or operation can be obtained.

In other words, as the second step, as to an intention, which the nature structure of the intention is, independent, common or contrary, the operable structure of the intention, such as the operable range of a brake and a steering wheel used to avoid collision, collision prevention as the goal (objective function) of the intention and the like are defined. In this step, as intention definition preparatory support process, a template is set in the operable structure.

Then, as the definition of a support structure for intention realization, the specification of a partial recognition function and the like is determined in order to extract the feature structure of the environmental data of a target, such as whether the road has curves.

Lastly, a strategy and tactics are defined. A strategy is the generic constraint on an operation to realize an intention, and as the strategy, a constraint on the environment and a physical operation, an operation for goal achievement and the like, are defined.

Then, tactics are defined. Tactics can be obtained by embodying the general operation of a strategy. By receiving a user's operational instruction by data drive or the like, the generality is converted into concreteness.

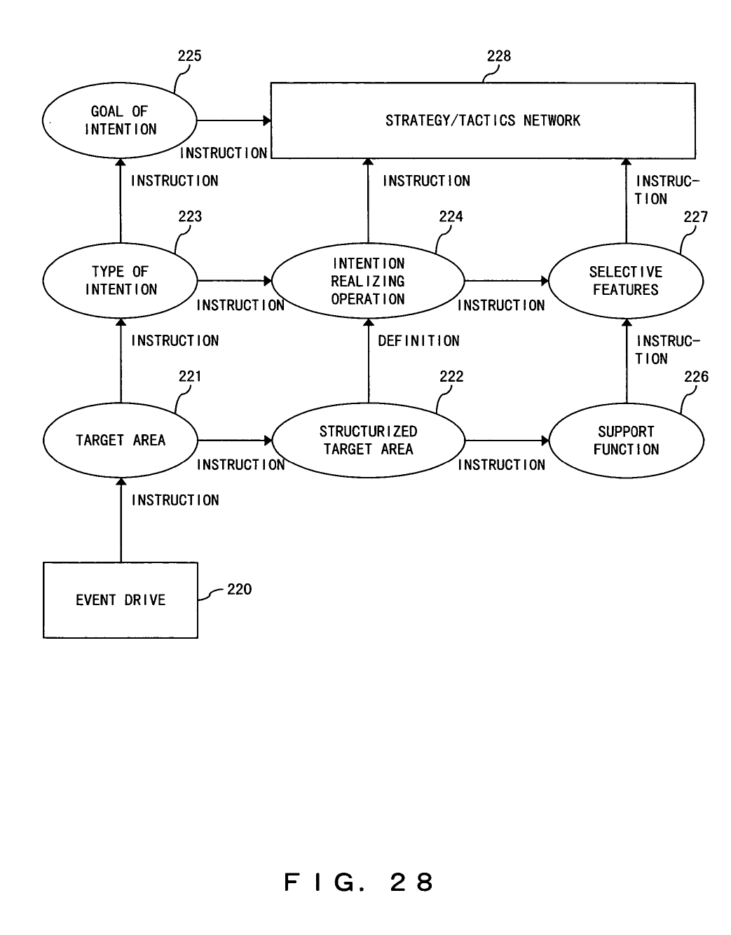

FIG. 28 shows the entire configuration of a generic object network for finally determining a strategy and tactics in order to realize an intention. As described with reference to FIG. 27, the target area of intention realization is a generic noun object. Then, a target intention can be realized according to the flow shown in FIG. 28 by receiving an instruction on the target area that matches the intention and is selected from a list displayed on the common platform by “event drive” 220 by a client. In this case, firstly, in the intention definition structure including the attribute structure of the target area, generic items as described with reference to FIG. 27 are embodied one after another.

In FIG. 28, at first a party, such as a client as a user has no intention at all. Then, the user's target of interest, that is, a target area 221 is designated. Since at this time, a specific target area is not defined yet, a list of target areas supplied by the system is displayed on the common platform by a data drive method, and the attribute structure of the target area 221 designated by the user, that is, a structured target area 222 is defined. If facing traffic is selected as the target area 221, as the attribute of the structurized target area 222, for example, two automobiles are defined.

Then, when the user designates an intention type 223 on the operation window, as event drive, the system makes an inquiry about what the intention as data drive is, independent, common or contrary. Then, the user designates one of “independent”, “common” and “contrary”. In this example, a common intention is selected.

Then, the user determines the operable structure of the intention, that is, the contents of an intention realizing operation 224, such as the operable range of an accelerator, a brake and a steering wheel and the like, by filling out the undefined data of a template based on the intension type 223 and the structured target area 222. Then, as an intention goal 225, an intention to cooperatively avoid collision is defined. Then, as a specific goal, the intention is expressed as the passing each other of the two automobiles at the minimum allowable distance, and the contents are displayed on the message window as a message from the system.

In order to realize an intention, data about the environment is needed as described earlier. Specifically, a role for extracting the amount of feature from environmental data and supporting to determine the amount of operation is needed. As this support role function, a support function 226 suitable for the target area is selected. For example, in the case of the facing traffic, as it, a GPS road map for an area developed in the travel direction of an automobile, an opposing car travel prediction system as a camera system or the like can be used. For example, a support role function to display the travel data of the opposite automobile on an enlarged road map of a GPS screen as vectors is selected, and a support structure for realizing the intention and the specifications of a recognition function are defined. In response to data drive 227 by a selective feature 227, the undefined data about the travel feature of the two automobiles in a template structure is assigned.

The controllable amount of operation is defined with constraints by the intention realizing operation 224 in advance. In the case of the facing traffic, the amount of steering calculated based on the current travel speed of the automobile is added as one constraint. Then, in response to the input of the intention goal 225, an intention realizing operation 224 and a selective feature 227, a strategy and tactics are determined by a strategy/tactics network 228.

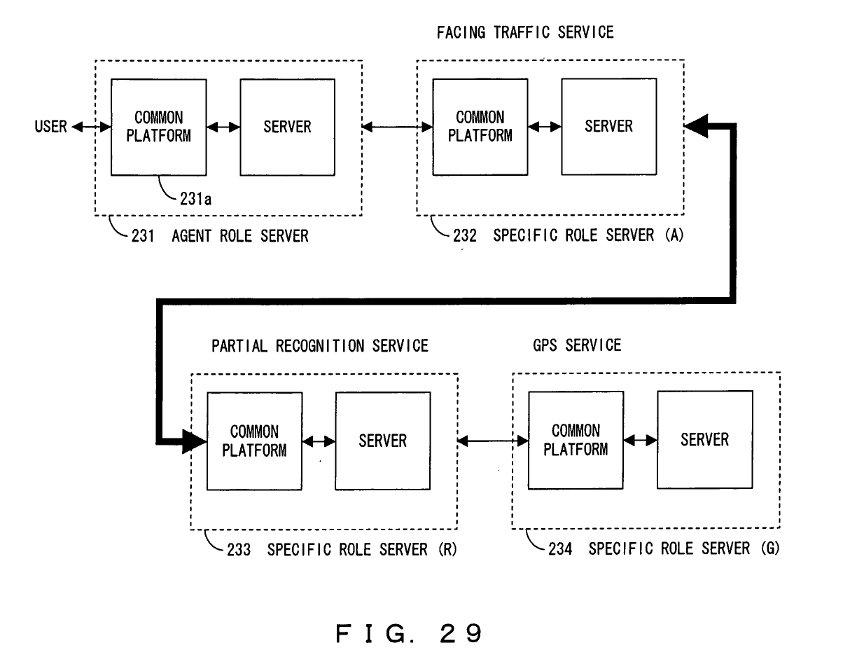

FIG. 29 explains the connection structure between servers for realizing an intention. FIG. 29, In an agent role server 231, a specific role server (A) 232 realizing a facing traffic service, a specific role server (R) 233 realizing a partial recognition service and a specific role server (G) 234 are connected.

A generic object network defined by an agent expert is displayed on the common platform 231a of an agent role server 231. This network is displayed as a graph, using both a generic noun object and a generic verb object. In order to convert this generic object network into a concrete specific object network, the parameter of the changeable part expressed as generality must be embodied, and a user is required to instruct the conversion of the generic name into a specific name as data drive. By this instruction, for example, the facing traffic of the two automobiles is selected as a target area.

Then, a specific role server (A) 232 capable of realizing facing traffic is selected from a database, and is connected to the agent role server 231. Then, in response to a user's shift instruction from the intention type 223 to the intention realizing operation 224, a template corresponding to the amount of operation is set.

Similarly, if a support function 226 is designated on the common platform 231a of the agent role server 231, a list of selectable items is displayed on the common platform 231a. Then, if a GPS service is selected by the user, the GPS function or a simulator is referenced, and the specific role server for a partial recognition service (R) 233 to which the specific role server for a GPS service (G) 234 executing the function is connected, is connected to the specific role server (A) 232 for a facing traffic service.

Then, a partial recognition function of the amount of feature constraint designated by the selective feature 227 is realized by the specific role server (R) 233. Specifically, the necessity of the function of the specific role server (R) 233 is designated by the specific role server (A) 232, and the specific role server (G) 234 is specified as a support role function to meet the requirement. As an appropriate visual recognition function, for example, a human being can also be set.

As described above, in order to embody a generic strategy and tactics for intention realization, an expert determines them. Alternatively, a user that executes an intention can experience such embodiment and can embody them by his/her learning function. In the former case, a method and a structure needed to realize the intention are determined top down, and in the latter case, the method and structure are determined bottom up.

Next, the service system targeted by the present invention is described in detail. In the service system targeted by the present invention, each of a party as a client which requests for services, a party as a server which provides clients with partial services or provides services by integrating those partial services and the like, comprises an intention realizing data processing device using, for example, the WELL system as its core. Simultaneously, comprehensive external environmental data as common data for a service execution process is collectively managed so that each party can refer to the data in parallel at a required time. The intention realizing data processing device basically performs an object-oriented data processing. The object is hierarchically composed of the above-mentioned four models of a data model, an object model, a role model and a process model. Each model operates independently from each other and in parallel to each other.

Each server providing services to client comprises a role corresponding to the specialty of each service. The servers are managed by an agent role server, and each service is executed by a specific role server related to its special service business. A server supporting the execution of the service business also has support functions to improve the quality of the service network, such as interactive communication, planning/designing, interface, security management and the like.

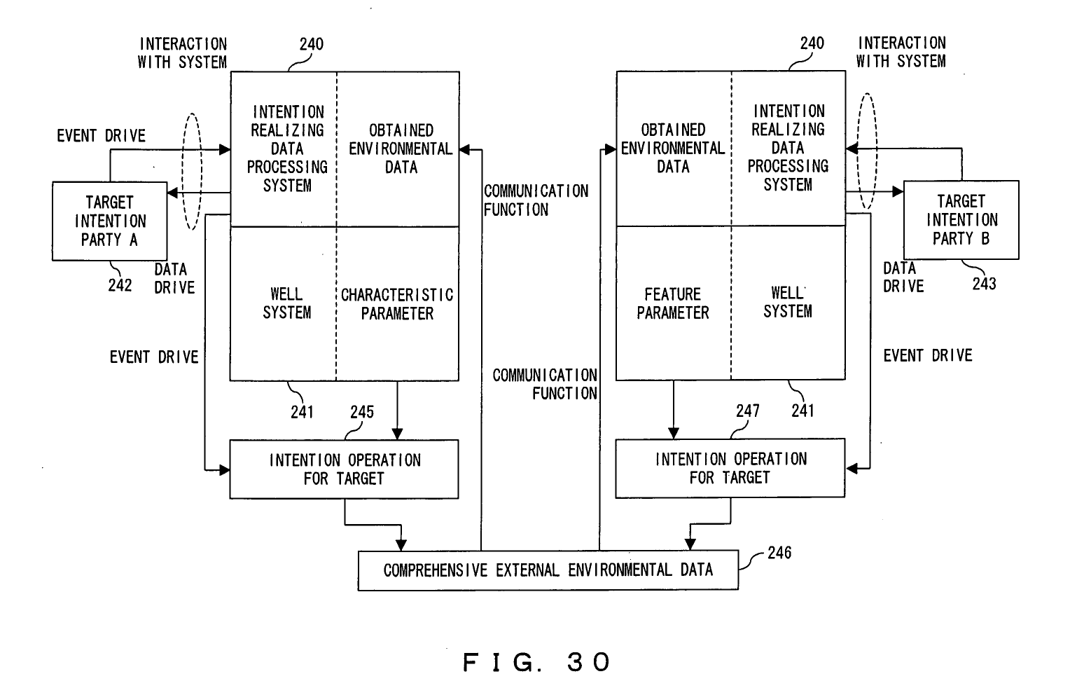

FIG. 30 explains a communication function in the course of the execution of an intention in the service system. In FIG. 30, a bi-directional interaction function is realized between a plurality of parties A and B through comprehensive external environmental data.

In FIG. 30, for example, event drive related to a target intention 242 is supplied from a party A to an intention execution system 240, that is, an intention realizing data processing device. The intention execution system 240 comprises a WELL system 241 as its core function.

The intention execution system 240 enables an external operation device to apply an intention operation 245 to the target as event drive in response to the intention of the party A. Thus, the operation is reflected in the comprehensive external environmental data 246. The result of the intention operation is stored in the comprehensive external environmental data 246 as the feature parameter of each party.

Similarly, a target intention 243 is supplied from a party B to the intention execution system 240. As in the case of the party A, a feature parameter is stored in the comprehensive external environmental data 246 by the application of the intention operation 247 to the target.

When making the external operation device apply the intention operation 245 to the target by event drive in response to the intention of a party, the intention execution system 240 maintains the uniformity of the system by referring to the contents of the comprehensive external environmental data using the communication function and determining the matching of data using the contents of the obtained environmental data.

If in FIG. 30, parties A and B have a common intention, both the parties cooperatively operate so as to realize the common intention. Even if each of the parties has a contrary intention, each of the parties uses the WELL system to recognize the operation of the opposite party. Thus, necessary environmental data is extracted from both the data possessed by each party and data displayed on the common platform for displaying comprehensive external environmental data by a support role function, and the cooperative or contrary relationship can be processed.

In FIG. 30, for example, media information is handled by the WELL system, and interaction is conducted between the parties by bi-directional interaction function. In this interaction process, the intention execution system 240 comprising a generic object network for intention realization described with reference to FIG. 28 performs a core function. An interactive function is based on interaction between two parties A and B. However, in the interaction between a lot of parties, there is a correlation between the respective intentions of the parties, and each party adjusts his/her intention to the common intention or contrary intention in the intention goal 225 shown in FIG. 28. Thus, the common intention or contrary intention can be realized.

If a plurality of parties are dynamically formed into a team, and the common intention, independent intention or contrary intention must be executed in a matched form among the parties in the team, it is important for the leader or manager of the team to check the matching as an agent in order to maintain the matching of the intentions of the parties in the team.

The comprehensive external environmental data 246 shown in FIG. 30 includes both the respective structure data of parties A and B related to the system and the attribute data of the target area related to the intention. The data 246 also includes data about the constraint items of each of the parties, which each party can recognize in response to the action, that is, intention operation against the target.

The target intention of the party A or B shown in FIG. 30 is reflected in the contents of an operation including a strategy and tactics for an action to be taken by the party, against the target area of the intention, the definition structure of which has been described with reference to FIG. 27. When applying the intention operation to the target in response to the target intention, the comprehensive external environmental data 246 is referenced to obtain the feature data of external environmental data using a support function, that is, communication function, and an interaction operation is started as interaction between the party and the system.

In order to perform such an interaction operation, the party uses an appropriate terminal. The function of the terminal in the WELL system is to issue an instruction by event drive on the window described with reference to FIG. 7, that is, a window displaying a strategy/tactics for realizing the intention and the like, as generic object networks, to embody the generic object networks one after another, and to match them with the comprehensive external environmental data to realize the intention. In this case, if the comprehensive external environmental data 246 changes by the opposite party's intention executing operation, an operation must be performed depending on the respective changes of both the object network and data on the display to adapt the data to the real environment.

When executing the intention, interaction with the system is hierarchically conducted one after another to achieve the goal of each party's intention, for example, based on an independent intention. Specifically, the gradual embodiment from a generic object network to a specific object network is conducted as an interaction process according to each hierarchical object structure of a data model, an object model, a role model and a process model.

Specifically, an adaptive operation is performed in order to realize the intention of each party using the bi-directional interaction function shown in FIG. 30, according to a series of intentions generated by each party through interactions with the system, that is, the time sequence of a unit intention as a simple intention. This adaptive operation is conducted by referring to a comprehensive external environment including the opposite party, that is, the comprehensive external environmental data 246 and embodying the strategy/tactics of the generic object network of the intention. In order to change a dynamic process for achieving the goal of the intention, a matching constraint for dynamically controlling the verb object described with reference to FIG. 26 is used.

As the simplest interaction method in FIG. 30, one party and the other party are a user as a client and a server providing the user with services, respectively, where each of the respective intention realizing data processing devices of both the parties is provided with a WELL system and communication is conducted as interaction between both the parties. In this case, if media information is provided for the user as a service, multimedia contents using moving pictures as their core becomes the target of the intention.

As to the intentions of the concerned partiers, the attribute structure of the intention described with reference to FIG. 27 is defined, and its embodiment from a generic level to a specific level is conducted. In this case, both the name of the target area and attribute structure of the intention of each of the concerned parties are designated. As described earlier, if, for example, road traffic is a target area, a target object as a party moving on a road must be defined as an attribute structure in the target area. As a result, the structure target area 222 described with reference to FIG. 28 is embodied. For example, a scene and characters are embodied according to the multimedia contents.

As to interaction conducted to execute a service, it is important to designate the strong field of a party in charge of each item of the service and to plan and design so that comprehensive supplement by strong fields can be made by the interaction.

The attribute structure of a party's intension has been described with reference to FIG. 27. As the target of an intention for a client to use a service, the target area shown in FIG. 27 is designated. In this case, a trigger is for the client to determine that the use value is appropriate for his/her intention.

For example, in order for a client to have an intention to drive an automobile on a road, its use value is evaluated by how much benefit the client can obtain by an environmental structure provided to execute the service as the nature structure of the intention. Specifically, the use value is evaluated by the reciprocal relationship between a support structure as a feature structure of the service, such as in how much speed the automobile can run, signal facilities, road situations, opposing lanes and the like, and the driving operation of the client.

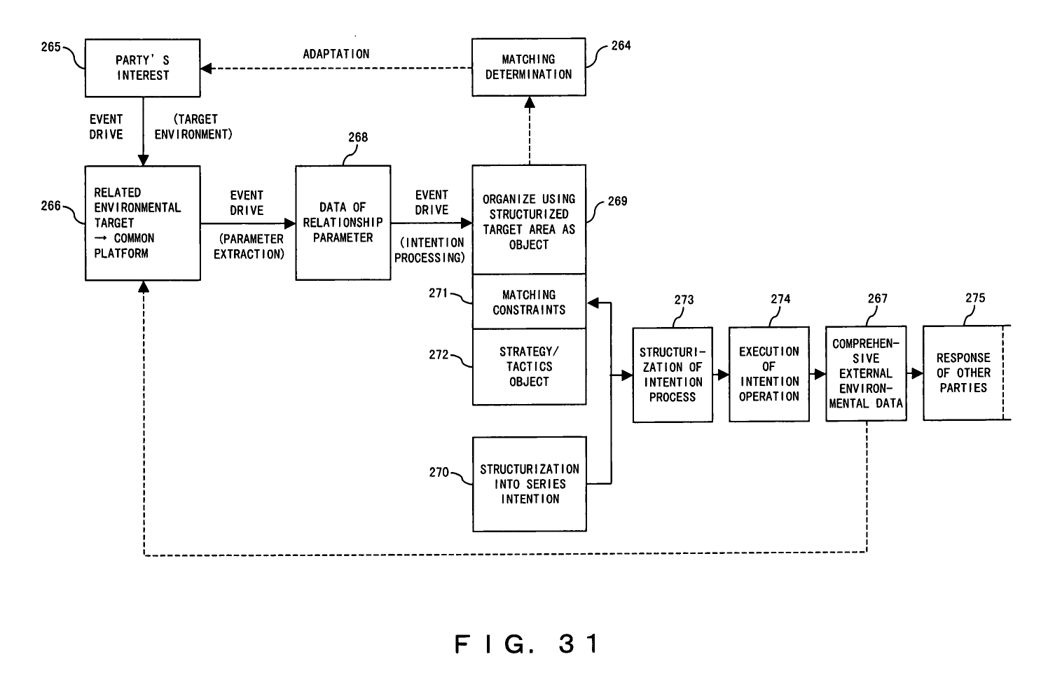

FIG. 31 shows the flow of the intention realizing process of each party by event drive. In FIG. 31, firstly if the WELL system designates a target environment as event drive in response to the interest 265 of a party, data corresponding to a related environment target 266 is extracted from a comprehensive external environmental data 267 and is displayed on the common platform. Then, the party extracts an interesting parameter as event drive, and the data 268 of the related parameter is supplied to the intention execution system, that is, the WELL system, as event drive.

Then, in the WELL system, the building 269 of the structurized target area as an object is made in response to this event drive, and a strategy/tactics object 272 is embodied by both the building of a series of intentions 270, that is, the sequence of unit intentions and matching constraints 271. Then, the building of an intention process 273, that is, a process corresponding to the series of intentions, and an intention operation executing process 274 is performed. Then, the result is reflected on he comprehensive external environmental data 267.

The results of processing matching constraints 271 by the intention execution system and the like become the cause of adaptation to the interest 265 of the party, depending on the result of processing matching determination 264. In other words, there is a possibility that the adaptation of a unit intention as the interest of the party, that is, the change of the interest may occur in the course of intention execution. The response of the other party 275 is the same as that shown on the left side of the comprehensive external environmental data 267, which indicates that an intention execution is similarly applied to the other party by event drive.

In the intention execution described with reference to FIG. 31, the execution is verified using matching constraint items corresponding to the noun and verb objects described with reference to FIGS. 23 and 24, respectively. The statuses of the noun object 204 and verb object 207 shown in FIG. 23 show the statuses of the objects to be processed in FIG. 31 and are related to the data control of matching constraints.

Both the attribute structure of a target area and the member composition of parties as the components of the service provision system must be adaptively managed. For this purpose, the attribute item relationship in features between a target area and a party is analyzed. In order to analyze the relationship, the following bi-nominal classifications are needed for the WELL system as separation attributes for making an instruction on the expression of the generation, process, recognition and the like, of a service information item.
(1) Status/operation
(2) Priority/waiting
(3) Item/function
(4) Preparation/operation

As the intention reciprocity of a service, there are the following bi-nominal classifications.
(1) Cooperative/contrary
(2) Occurrence/increase or decrease
(3) Matching/non-matching (malice)
(4) Generic/specific

As the relationship between an environmental item and a party, there are the following bi-nominal classifications.
(1) Compound/single
(2) Consideration/oblivion
(3) Series/parallel

As to the group intention of an aggregate of parties, it is necessary to plan and build it so that such attribute classifications may be matched and adapted to each other.

In this case, by a lot of clients requesting a specific service system to provide a service or supporting a service environment, a lot of related parties give a variety of influences to its service effect. When studying the service effect, it must be noted that the relationship in intention between the related parties becomes an important factor. In particular, it is essential to analyze a strategy/tactics network for realizing the intention goal of each related party.

As to a service intention, there are (1) a general group of clients that use services with goodwill and (2) a partial group of clients that use services with malice. If clients can be classified so, in order to maintain the security of the system, it is necessary for the system to apply adaptation to the introduction of the feature model of a client with a malicious intention.

For example, in the case of road traffic, the intention goal of a client that uses a road service with goodwill is for a lot of clients to cooperatively use the road. However, the intention goal of a reckless driver is to rudely show off his/her driving skill and to intentionally disturb the road traffic of other good clients. Therefore, the intention of the reckless driver and that of the good client are contrary from the viewpoint of service use.

From the viewpoint of the social service of the circulation of paper money, a main intention is to circulate regular paper money in the market cooperating with a lot of citizen, and a person that manufactures counterfeit bills with malice and obtains an illegal benefit is considered to have a contrary intention against the social service.

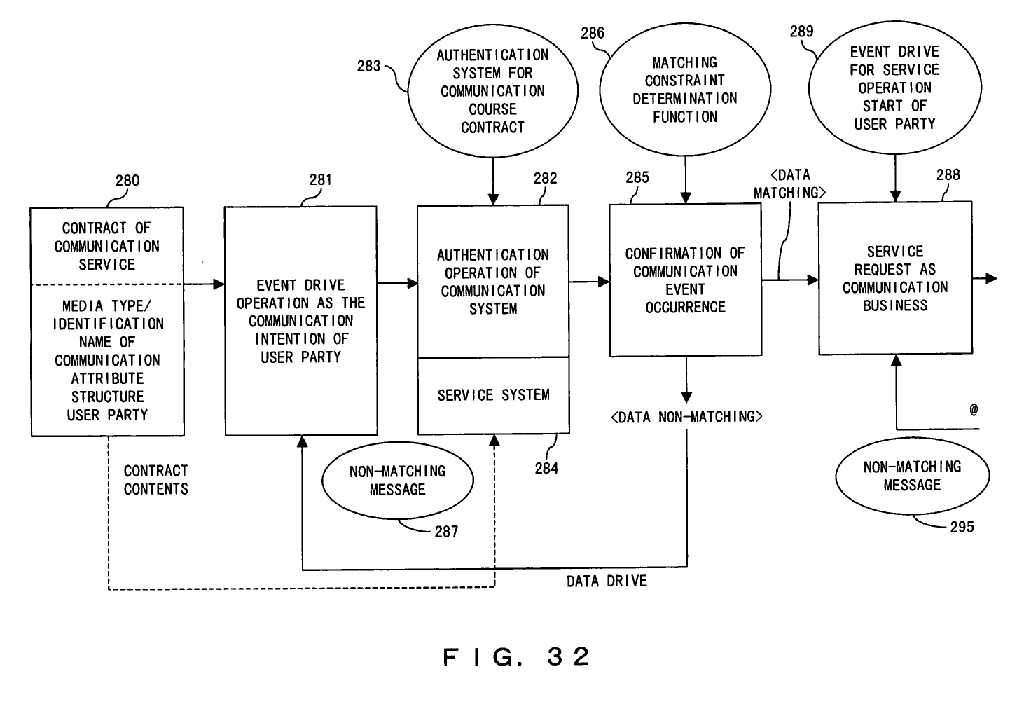

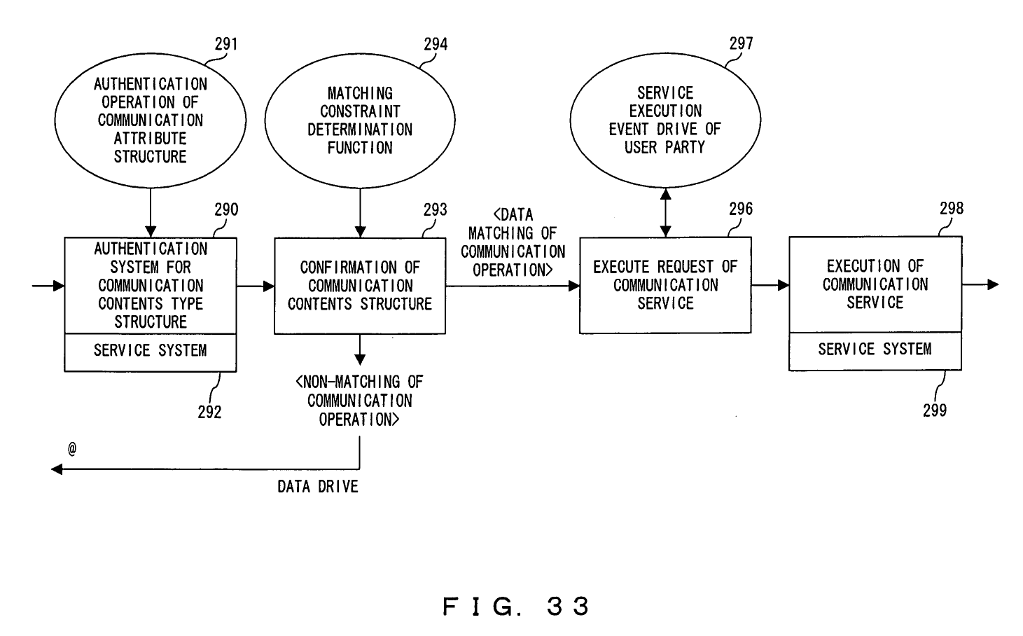

When doing service business, the client and server perform an efficient process using the interaction function of the system. This process is realized by the flows shown in FIGS. 32 and 33. The goal of the process is the following security and cooperativeness of the system.

(1) Security of the System

The security of the system is secured in the following points by an interaction process.
a) In order to secure communication in the system, the legality of a connection is checked by the authentication of a communication connection. Specifically, the operational guidelines are observed.
b) The privacy of data provided for a client is protected, and the privacy of client's attribute values is also protected. Specifically, the propriety of matching constraint items of data is checked.
   (2) Cooperativeness Among Related Parties

If a lot of parties cooperate to execute a specific service, all the parties must have a common intention goal and the goal must be achieved by a specific party executing the service. Alternatively, a plurality of parties must cooperatively execute the service to achieve the goal. Therefore, adaptation is required to be applied to a strategy and tactics so that the role function of each party can be achieved.

FIGS. 32 and 33 explains an interactive function by communication to be performed for such cooperative execution.

In FIG. 32, firstly when in the communication service agreement 280, an agreement is concluded using the type of media, such as the type of a telephone line, PHS, etc., a communication attribute structure, the identification of a user party and the like, and an event drive operation 281 as the communicative intention of the user party is performed, the authentication operation 282 of the communication system is performed. Although this authentication operation is performed by an authentication system 283 of a communication process agreement, the contents of the communication service agreement 280 can be used by a service system 284 in order to support the authentication operation, if necessary.

Then, when the confirmation 285 of the occurrence of a communication event is made, the matching of data is checked by the determination function 286 of matching constraints. If the “non-matching of data” is detected, a non-matching message 287 is issued in response to the event drive operation 281 as the communicative intention of the user party. If the “matching of data” is confirmed, a service request 288 as communication business is issued in response to the event drive 289 for service operation start of the user party.

FIG. 33 explains a communication service execution process following the service request 288 as communication business shown in FIG. 32. In FIG. 33, in response to the service request 288 as communication business, the authentication operation 290 of the communicative attribute structure is performed. Although this authentication operation is performed by an authentication system 291 of communication contents type structure, the operation can be also supported by a service system 292, if necessary.

Then, the confirmation 293 of a communication contents structure is made. By this, the contents are checked, for example, it is checked whether all communication contents are written in capital letters. This is checked by the determination function 294 of the matching constraints. If the “non-matching of a communication operation” is detected, a non-matching message is issued by data event in response to the service request 288 as communication business shown in FIG. 32. This non-matching message is one about the communication contents structure.

When the “non-matching of a communicative operation” is confirmed by the confirmation 293 of the communication contents structure, the execute request 296 of the communication service is made. This execute request corresponds to event drive 297 as the service execution process of the user party, and in response to this execute request 296, communication service execution 298 is made. This service execution is supported by a service system 299.

Next, in this preferred embodiment, a process function is described using a reference model for the purpose of an efficient process. As described earlier, the flow of a process is basically specified by a method for expressing the operation of the system, including event drive and data drive, according to the intention of a user or a party. In this case, the reference model is defined in connection with the operation of an object network, and the method is also closely related to the design method of general system architecture.

As described earlier, when during the user process of an object network, for example, a user requests for a specific execution service, event drive is performed. However, if a parameter in a template is undefined or unmatched in the course of the process, the system requests the user or an appropriate party to provide a data value. This function is data drive.

In this data drive, required data contents are assigned, for example, to a currently undefined cell position, which is called a “data definition operation”. As the paired function of the data drive of a noun object, a verb object is provided with a similar function, and a service executing operation, that is, the execution of a function process is requested for a party that executes a service.

Reference drive is defined as the process form of the reference model, based on the event drive and data drive. By this reference drive, for example, a service to be executed by the reference model is requested for the system. Generally, an object network name, a role function name, a process name and the like are structured in the form of a generic or specific object network. In other words, the reference model defines the basic driving method of an arbitrary structure.

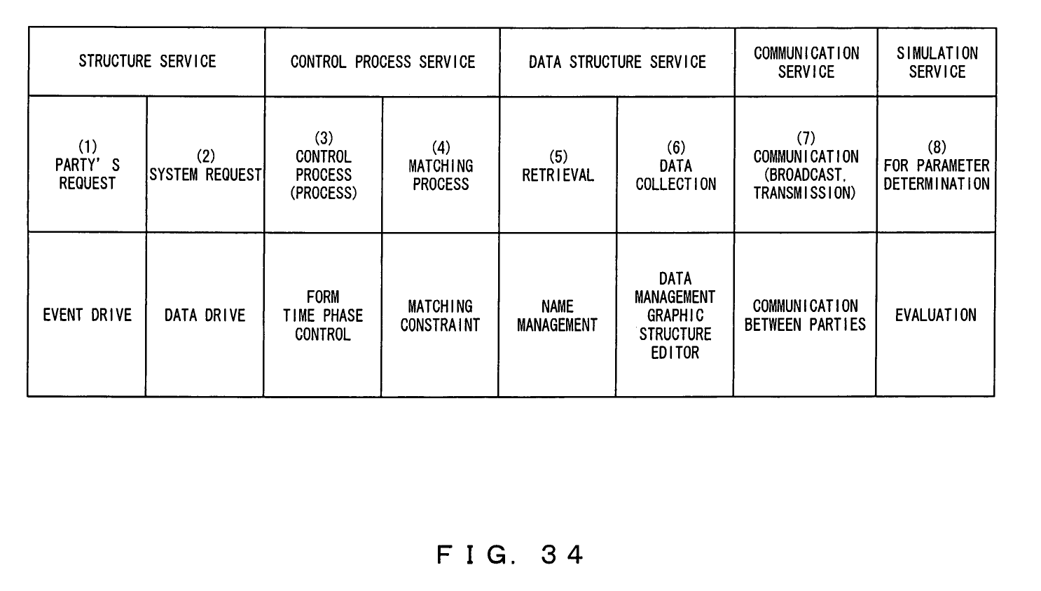

FIG. 34 explains services by the reference model. By the reference drive, firstly the name of a structure is designated. Then, the reference model realizes a basic operation of converting the structure name from general to specific one after another as the basic service shown in FIG. 34.

The first basic service item is a party request service, which requests the system to execute the function of an object whose name is designated by a party. This service corresponds to event drive.

The second service item is a system request service. For example, when the contents of a template are undefined, the system requests an appropriate party to define the cell contents of undefined data. This service corresponds to data drive.

The third service item is a control process service, which is a function related to the process model. This service controls the drive, stoppage, synchronization and the like of its own and other object networks, in connection with the execution of the process of an object network.

The fourth service is a matching process service. This service is related to the nature of an object defined as a matching feature in matching constraint items. This service determines whether data provided by the object environment at that time satisfies the nature, selects a proper control process according to the determination result, and links the control with a process control. For example, it links the control with a control process of satisfying the systematic correspondence between input and output as a series of operations for the process.

The fifth service item is a retrieval service, which, for example, searches for an object whose name is designated by a party.

The sixth service item is a data collection service. This service collects the respective amount of selective features in a role function corresponding to a plurality of parties, and generates a database.

The seventh service item is a communication service. For example, this service provides the contents of a communication template in broadcast type or individual destination type communication.

The eighth service item is a simulation service as an adaptive service, such as an evaluation service for parameter determination.

For each of a series of the above-mentioned services, an actual execution process is described.

The reference model is independent of and orthogonal to the hierarchical structure of an object composed of the above-mentioned data model, object model, role model and process model, and realizes the service shown in FIG. 34, of the system, in the form including data up to a collaboration execution model, in connection with the event drive and data drive.

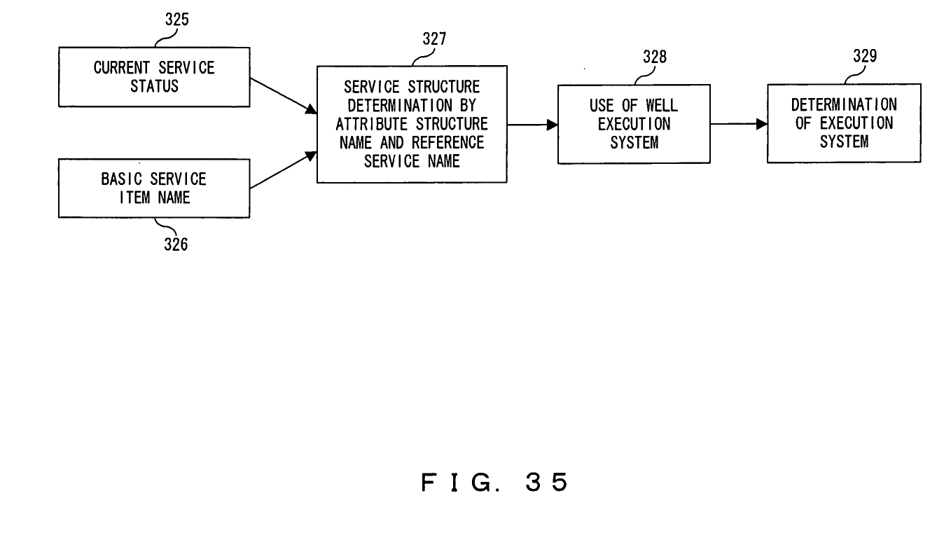

FIG. 35 explains a method for realizing the reference model by the WELL system. In FIG. 35, both an attribute item name and a reference service name are determined by both the current service status 325 and the basic service item name 326 of the reference model, and a service structure is determined by both the attribute item name and reference service name (327). Then, by using the execution system of the WELL system (328), an execution system is determined (329) and a reference model is realized. Thus, the existing WELL system is effectively used and can be operated by software.

In order to realize the basic service items described with reference to FIG. 34, as the reference drive, an expert must plan/design a real process system as an application and realize generic/specific object networks. Then, a user must efficiently use the structure.

In order to use the basic service items in reality, a template with an attribute structure composed of a service item name, a list of service target names, a template structure (template according to service contents), control parameters (parameters for the start, stoppage and synchronization of matching constraint items), a selective feature name (the recognition role of environment data and a link) and matching constraint items (data as a process) must be provided.

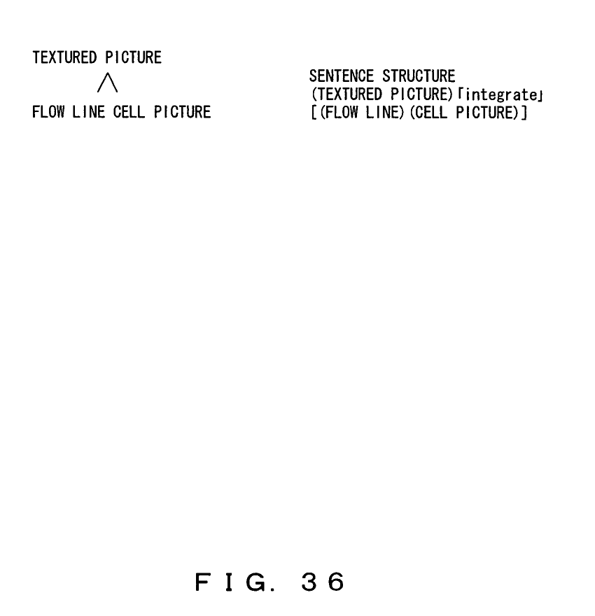

The hierarchical structure and matching constraint items of an object are described in more detail using a textured picture as an example. FIG. 36 explains constraint description by both the graphic display and sentence structure of a texture painting corresponding to the generation of a color picture shown in FIG. 8.

In FIG. 36, “TEXTURED”, “CELL” and the like as adjectives are added to “PICTURE” as a noun object. The object network as an adjective phrase has a generic character and modifies a noun object network. Specifically, as a system, a preferred structure is given to an attribute value as a parameter value of “LINE” and “PICTURE” by the hierarchical constraint shown in FIG. 36.

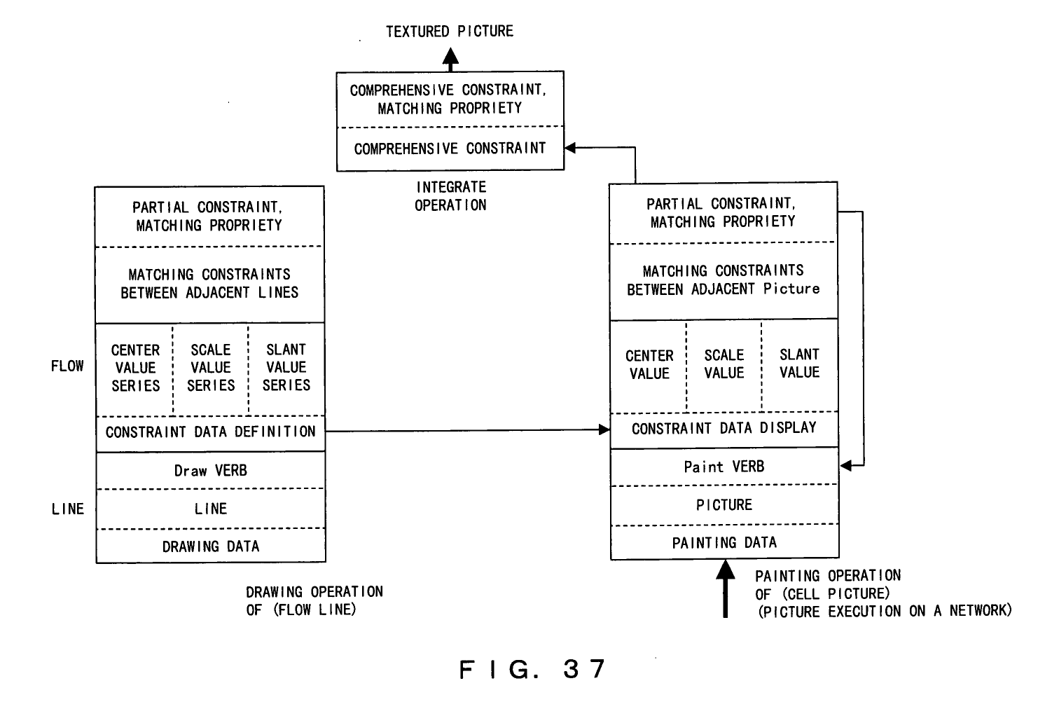

FIG. 37 shows the flow of the sentence structure software of a “TEXTURED PICTURE”. In FIG. 37, a noun object of “LINE” is started by a “draw” operation of executing it, and constraint data designating the center position of a cell picture to be placed on a “FLOW LINE”, dimensions and an angle of inclination is defined by the values of “center”, “scale” and “slant” as attribute values.

The operation of “INTEGRATE” shown in FIG. 37 performs a function to integrate “FLOW LINE” and “CELL PICTURE”. In this case, it integrates matching constraints defined in “FLOW LINE” and “CELL PICTURE” and checks the propriety of the matching constraints. A node portion expressed as a tree structure in the graphic display of FIG. 36 virtually expresses an editor integrating both, and this virtual function is important for an efficient system configuration.

As described using the examples shown in FIGS. 36 and 37, matching constraint items are defined for a generic/specific object, and the linking of matching constraint items between objects is made by interactive function by communication as the support function described with reference to FIGS. 32 and 33. In the adaptive process of intention execution described with reference to FIG. 31, an adaptive change according to the environment is made by the determination of the propriety of matching constraint items.

Its contents in a noun object often covers the cell contents of a template, a feature parameter as data up to the deformation of a template format. In a verb object, it covers the change of an operation due to the change of the template format, the change of strategy/tactics up to a modification due to the change of an attribute parameter.

In any case, a change occurs in a system in which both definition preparation for adaptation and a definition operation adopt a designation role function. In order to adapt, the increase of serviceability, the elimination of the causes of service disturbance, the increase/adjustment of service data are necessary, and for that purpose, the adaptation of a service network structure must also be examined.

Although the description of the summary of both the WELL system and intention realizing data processing device has been finished here, in this preferred embodiment, a WELL system is used to build software architecture for integrating target areas intended by each of the clients of a service system as a whole, describing the flow of data drive and executing it. Although the WELL system was conventionally used mainly in a software field mainly handling pictures, as described earlier, this WELL system has recently been realized as a comprehensive software system that fits in an arbitrary field as a field descriptive type in the form capable of extending the description of an operation as requested, as follows.

(1) Comprehensive Realization of a Variety of Media:

Designing of interesting scenes, incorporation of individual environmental data, role of a player, scenario and support role

(2) Common Platform:

Dynamic adaptation of service execution and reception through a platform, and dynamic execution of event and data as information

(3) Notation:

A variety of notations are available depending on the position of a party. A party can understand the contents by properly translate them. For example, the contents can be visibly displayed and be logically expressed using an object network.

(4) Constraint Item Control:

Security control can be described.

(5) Model structure:

Since a function can be easily hierarchized, process description can be simplified.

(6) Intention Processing:

Since a service intention can be expressed as an intention execution network, and its target and area can be defined, the service intention can be clearly systematized as the contents of an interface between a service requesting party and a service providing party.

(7) Network Service:

The cooperation, reciprocity and independence in a network of a party can be described, and a sense of game can be adaptively expressed. Furthermore, since environmental data can also be made a network, a cooperation or reciprocity by support can be executed in a database as a service.

A wide range of and a large amount of information socially occur and are expressed as multimedia. Related information must be structurized into a database in a simple and clear expression. Simultaneously, since information should be always updated from the viewpoint of life cycle, information must be managed by evaluating it from time to time.

By making the system of data drive type, the drive of a system function is started by a function to extract features from the use intention data of a client, and the system operation generates a service. Then, its result is conveyed to the client, being a service requester, through an interface function, is reciprocally evaluated and is reflected in the management of the system. Then, the adaptation of system is made.

In the concept of “ubiquitous” as a target area in a computing system, a lot of equipment is built in a computer. As a network has progressed, life has become information-oriented around a user, and the importance of a service form where information can be easily used anywhere and at any time, a kind life-support service is adaptively promoted, and system software can be easily managed and used in case of emergency, has rapidly increased.

For this purpose, a user accesses a target on a network by data drive. In this case, the user performs a name management in which the user designates a target area and extracts a target from the list of targets. In this case, the list of detailed names related to their attributes can be retrieved so that consulting is possible. In this case, support is made by a hypertext type distributed data processing system where a link can be established between related names.

In order to realize the above-mentioned, the WELL system is provided with a model structure as a means for hierarchization, that is, a data model, an object model, a role model and a process model. An adaptive link technology based on the hierarchical structure of a service attributes as a visible system environment is automatically provided by display on the common platform.

By the network process function of the intention realizing data processing device, service contents can be selected so as to match the descriptive contents of a user intention. By executing a service according to an intention to cooperate and reciprocate on a network, an adaptive function can be realized.

As to a service target, as shown in FIG. 28, the target area corresponding to a client's intention and a target area obtained by structurizing it (structurized target area) are generated.

As the hierarchical structure for that purpose, it is necessary to select an operation item from the structurized support area, to designate and select its selective feature, to supply it to a strategy/tactics function and to embody it. For example, when handling a free-form surface Φ, which is described later, as a target component, a free-form surface must be set as an intention. As parameters needed to specify it, firstly feature points (special point, such as an upper peak point, a lower peak point, a saddle point, etc.) are designated, and by calculating a structure line (ridge line, trough line or partition line) using the parameter group, data is supplied. Furthermore, the luminance value and chromaticity value of picture contents are calculated using the structure lines, and coloring is applied on the screen.

Moving pictures as pictures obtained by changing an individual color picture timewise are integrated together with sound data, and multimedia data as a cut can be generated. Between cuts, data, such as fade-out or the like, is supplied as a variation structure.

As to the movement of a Kabuki actor, which is described later, too, makeup indicating the character of the actor and a costume pattern are provided as an attribute structure. For example, in order to express the role of a horse, the movement of the front and rear legs of an actor as contents data must be cooperatively linked with the movement of the other actors on a stage, samisen-music and story-telling. In this case, the movement of each component must be described as attribute data. In particular, as the relationship with the movement of another actor, parallel operations must be synchronized. For this purpose, matching data for cooperation is described by the data of matching constraint items to synchronize them.

Such an operation requiring cooperation or contrariness is realized by a data-drive type system mainly using matching constraints as its core. In order to enable the system to provide a comprehensive service, matching constraint items are given to all the intentions of an actor around the target area of each party's intention. Thus, an integrated service is realized. In this case, the sympathy to a service of a lot of clients is important. For this purpose, there is a commentator for each party. A comment service in an art museum is provided on each spot about the features of each exhibit, the course of its generation and the like. It is important to give impression to a watcher and to adaptively change the comment according to the reaction. In this case, it is important to convey the variety of reactions of the watcher to a comment service provider.

In order to enable the data-drive type system in which service providing parties cooperatively provide such a variety of services, and the reaction of the receiver of a service is adapted to effectively function it, the attribute structure of the service system must be diversified.

As the attribute structure of a service function, the following items are needed in addition to functions required to provide/receive services in the WELL system.
(1) A basic attribute needed to interact for question execution
(2) Structurized Attribute of a Target Area:
   Feature extraction, the definition operation of a strategy/tactics and a simulation execution process as one support function
(3) An evaluation attribute for service adaptation and the adaptive change of environmental design by its structurization
(4) As to a target, magic, tricks and the like must be expressed as services by pretence in a target area. Role contents are expressed to the same effect. The attribute functions of makeup, costume, gadget/stage setting and the like as a virtual realization are clarified.
(5) A synchronous attribute must be set using matching constraint items for cooperation, reciprocity and parallelization among a lot of role functions as an operation key.
(6) The legality of the entire system must be specified by role functions incorporated in a network. Matching constraint items including ones for setting operational security in the system must be formed into a template as the attribute structure of a service function.
(7) A system for measuring the degree of satisfaction appealing to the sensibility of a client and evaluating a sensibility value as the attribute of a target area to evaluate the system is necessary.

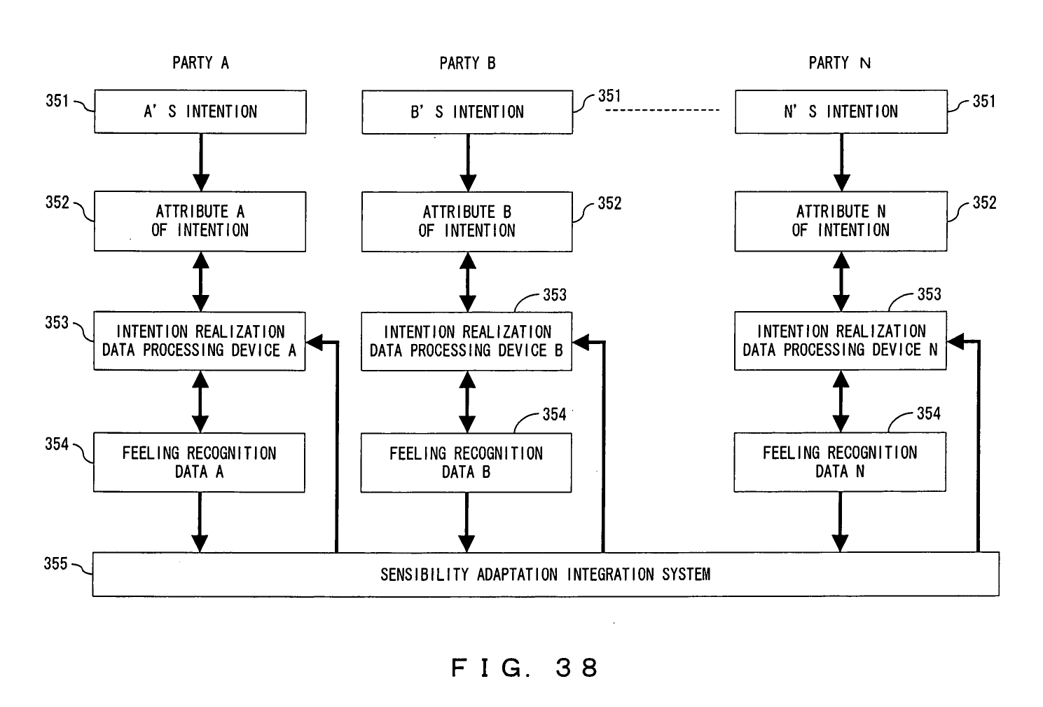

In the above-mentioned preferred embodiments, a system for, for example, describing the intention of a client as a party and the sensibility data of each party and incorporating them, is necessary. FIG. 38 is a block diagram showing the basic configuration of a service system based on the sensibility information of such a party. In FIG. 38, as to each of a plurality of parties A, B, . . . , N of the service system, an intention attribute 352 is extracted from the intention 351 of each party, and the attribute is supplied to an intention realizing data processing device 353 corresponding to the party.

A feeling recognition data 354 as the sensibility information of each party is supplied to the intention realizing data processing device 353 corresponding to the party, and simultaneously is supplied to an integration system 355 for performing the integration of sensibility adaptation as the entire service system. The result of the integration is supplied to the intention realizing data processing device 353 corresponding to each party, and the corresponding intention attribute 352 and feeling recognition data 354 are adapted to the data. In other words, the feeling recognition data of not only the party but also other parties are used for the sensibility adaptation as a whole.

For example, if each of a plurality of parties belongs to one of two teams each of which has a common intention and the respective intentions of the two teams are contrary, feature extraction is conducted according to the intention goal of each team, and for example, by the adaptation of a strategy/tactics using a support function, the degree of satisfaction of the feeling recognition data is gradually improved.

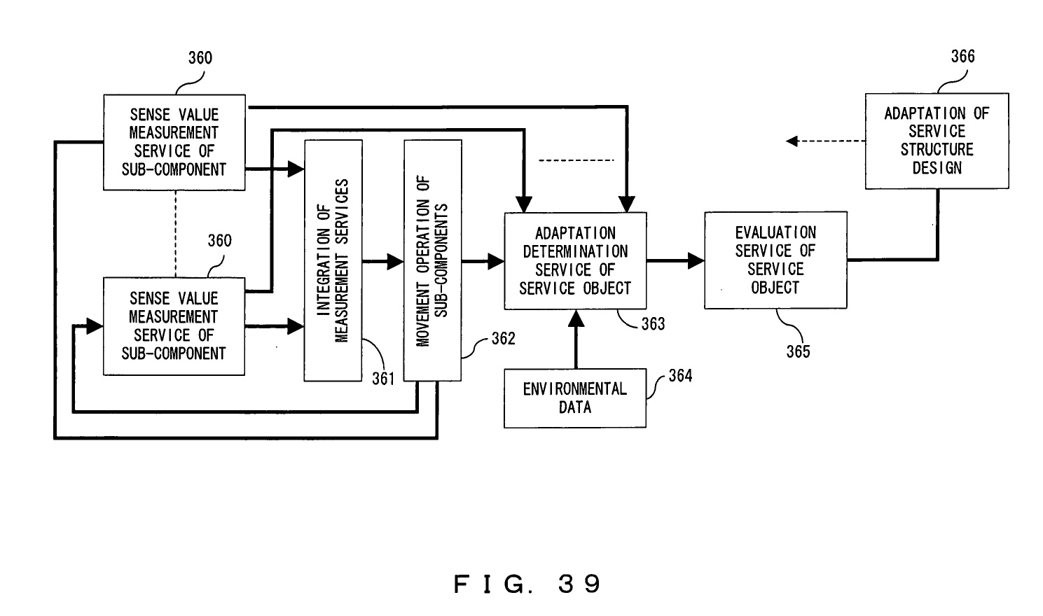

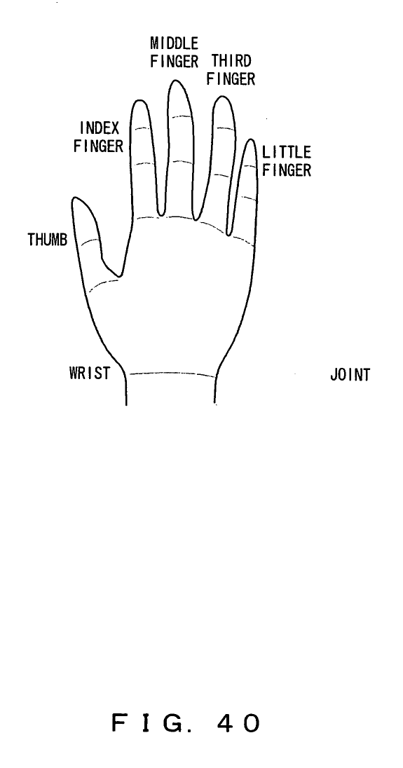

FIG. 39 explains a sub-component's service integration method for performing the adaptation of a service structure, based on the sense value of the sub-components of the system shown in FIG. 38. The operation shown in FIG. 39 is described with reference to the explanation of the adaptive operation of five fingers shown in FIG. 40.

In FIG. 40, the adaptation of five fingers as sub-components, such as holding a thing in a hand by the operation of five fingers, is performed. The bending and stretching operation of each finger is performed as a sub-component using the joint of a wrist, the two joints of a thumb and the three joints of each of the other fingers, and by integrating the feeling of each part, the shape, height and the like of a target to be held are measured. Then, by the operation for the held target, the functions of a hand and an arm are cooperatively operated so as to satisfy the aimed operation.

In FIG. 39, the measurement result of a sense value measurement service 360 of each sub-component is supplied to measurement service integration 361, and the result of the integration is supplied to the movement operation 362 of the sub-component. Then, the movement operation is re-measured by the sub-component sense value measurement service 360, and simultaneously it is supplied to a service-object adaptation determination service 363.

To the service-object adaptation determination service 363, both the measurement result of each sub-component sense value measurement service 360 and environmental data 364 are further supplied. The determination result of the adaptation determination service 363 is a service-object evaluation service 365. The result of the evaluation is supplied to a service structure design adaptation 366. The result of the adaptation is fed back to the movement operation of each sub-component and the like.

As one example of such a service integration method, there is the control of ball types in the pitching of a pitcher. This control can be considered to be the integration service of the entire body including a wrist. In order to be satisfied with its result, a comprehensive practice is needed. In the data-drive type system, a comprehensive external-environmental-data adaptation function in which the change of social situations as environment is specifically incorporated, is basically important.

Next, in a service system, the attribute structure of a service function must be provided as the attribute of its operation function, its connection function, energy and the like in connection with each hardware and software supplied by a client, and in particular structure features must be defined as the attribute of a target area for which a service is provided. This definition of structure features is described below using a free-form surface as an example of the target area.

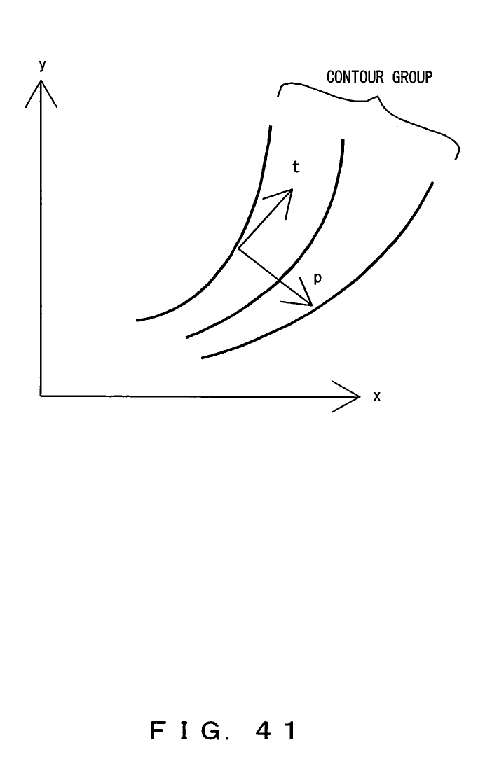

As a free-form surface defined by a scalar function on a two-dimensional plane, a surface defined by a scalar function that is defined on (x, y) coordinate axes, is considered. FIG. 41 explains a contour line vector and a force line vector that correspond to such a free-form surface.

The neighborhood characteristic of φ (x, y) in (x, y) neighborhood is expressed by the following partial differentiation of φ in the x-direction

$${ϕ}_{x} = \frac{\partial ϕ ( x , y )}{\partial x} \qquad [ Equation 1 ]$$

and the following partial differentiation of +in the y-direction.

$${ϕ}_{y} = \frac{\partial ϕ ( x , y )}{\partial y} \qquad [ Equation 2 ]$$

In this case, there is a method for expressing a vector that does not vary with the change of coordinates as a neighborhood characteristic using both a contour line vector t and a force line vector p.

$${X}_{p} = [ \frac{ϕ x}{ϕ y} ] , {X}_{t} = [ \frac{- ϕ y}{ϕ x} ] \qquad [ Equation 3 ]$$

If Xp and Xt in which t and p are used for a scalar coordinates φ (x, y) are considered to be vectors, they do not vary with the change of coordinates (x, y), and (Xt·Xp)=0. This is shown in FIG. 41.

Xt and Xp do not vary with the change of (x, y). As the invariant of quadratic differential, the following Hessian matrix is known, and an invariant can be generated using Xp, Xt and H.

$$H = [ \begin{matrix}ϕ x x & ϕ x y \\ ϕ x y & ϕ y y\end{matrix} ] \qquad [ Equation 4 ]$$

If as a unit vector, v and u are defined for Xt and Xp, respectively, as an arbitrary point (x, y) of a free-form surface, a local coordinate system (u, v) can be defined. Lines are expressed using this local coordinate system (u, v) as follows.
(C-line) C=φuv=0
(D-line) D=φvv=0
(E-line) E=φuu=0
(L-line) L=φuu+φvv=0
   C-line defines a line obtained by putting upper or lower peak points together, that is, a ridgeline or a trough line. D-line is obtained by putting the infection points of a contour line together, and separates a convex/concave mode. E-line and L-line indicate edges.

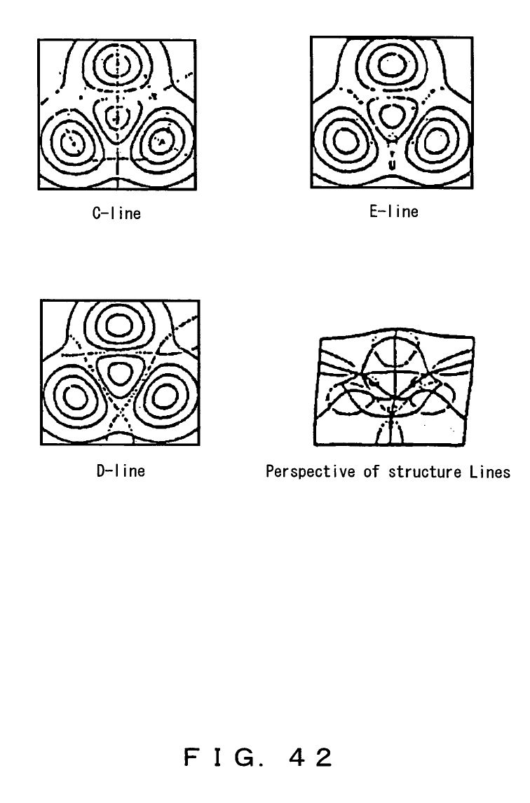

FIG. 42 shows such C-line, D-line and E-line. These lines are called “structure lines”, and are used to indicate the features of a free-form surface. Since this structure line mathematically indicates the feature of each target free-form surface, individually defines each free-form surface, the structure line can be used for the generation service of a free-form surface as a target.

As another example, the surprise attack at Hiyodorigoe of a warrior Yoshitusne Minamoto in Ichinotani battle of Genji vs. Heike War can be used. This example is found in one of Japanese classic literary works. When checking geographic features and planning how to attack the headquarters of Heike, Yoshitsune searched for a trough line with the assistance of a local hunter so that he cannot be detected by his enemy when going down the slope on horseback. As to the trough line, he confirmed that he could go down the slope on horseback without being detected, by actually setting a horse. Furthermore, as to the rough line, he emphasized that his attack could not be detected thanks to a mountain on the west side. In other words, he taught the hunter the geographic features necessary as a free-form surface, checked Hiyodorigoe for a corresponding place and found a point meeting the above-mentioned conditions.

Each of the above-mentioned examples requires to extract the features of a target in the target area as an intention, to operate according to the intention and to execute a strategy/tactics as a service. As a result, contents are generated. As a structure line in a three-dimensional function, a backbone line with a feature constituting the backbone is specified.

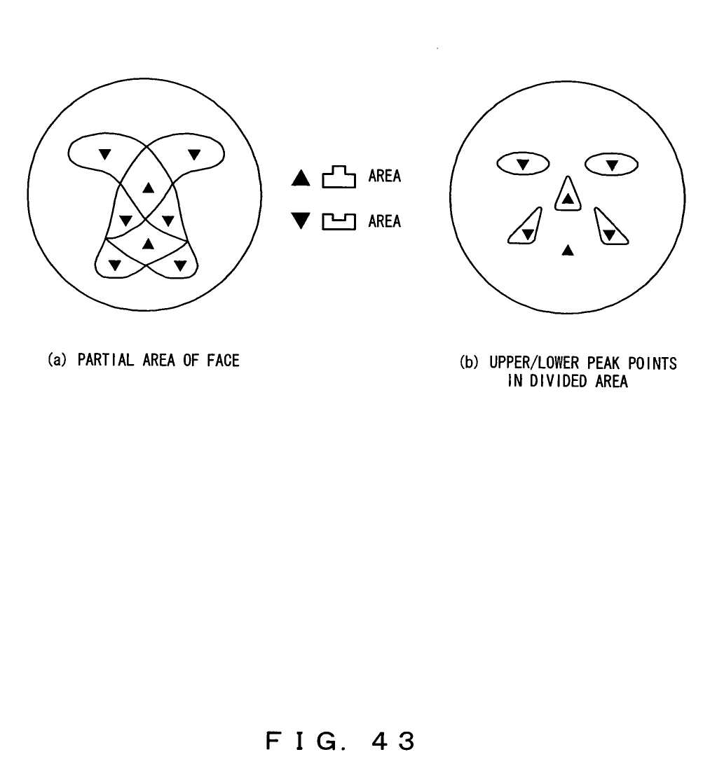

Feeling recognition data corresponding to such a free-form surface is described below with reference to FIG. 43. FIG. 43(a) shows the division of a human face into a convex area and a concave area in the case where the human face is considered to be a surface. By dividing a face in order to consider a human face, that is, expression as sensibility data indicating the sensibility of a human being and handling positions, such as an upper peak point, a lower peak point and the like, in a sub-area, the feeling recognition data described with reference to FIG. 38 can be obtained. In FIG. 43(a), the area of a face is divided into those of sub-components, such as eyes, a nose, a mouse, a cheek hollow and the like, of the sensibility data.

FIG. 43(b) shows an upper peak point, a lower peak point in the divided area. As described above, by considering a face as a free-form surface and mathematically analyzing it, a feature concept, such as a structure line connecting the upper peak point, lower peak point and between them or the like, is detected, and sensibility data as the result of client's feeling recognition can be obtained using such a feature concept. By performing logical analysis between such sensibility data and the mental function of a human being, the relationship between a feature concept, such as the upper and lower peak points shown in FIG. 43(b) and the sensibility information of a party, such a client, can be clarified. By using such a feature concept as sensibility data, a service that improves the degree of satisfaction of the client can be provided.

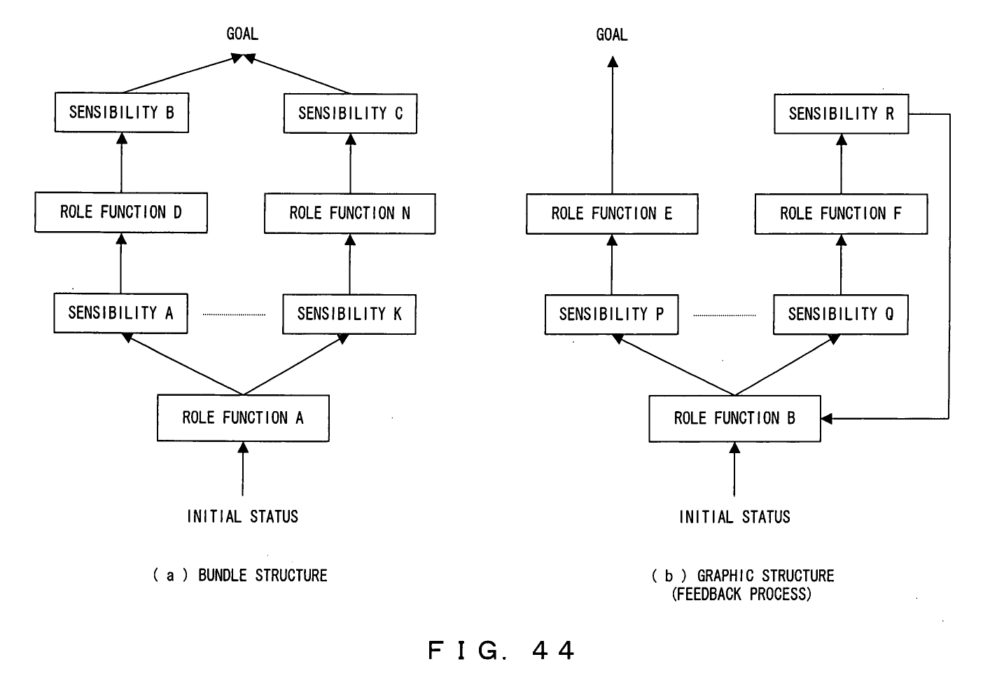

FIG. 44 explains the structure of a process course executed by a plurality of role functions. FIG. 44(a) shows an example of a bundle structure. In the bundle structure, sensibility A and sensibility K are obtained from the initial state by a role function A and are supplied to role functions D and N, respectively. Then, sensibility B and sensibility C are obtained and the intention goal is achieved. However, FIG. 44(b) shows a graphic structure as a feedback process in which sensibility R obtained by a role function F is fed back to the role function B.

Next, a sensibility service is described using a play as an example of a target area. Kabuki is currently most popular among Japanese classic plays. In Kabuki, both the change of setting by the set and cooperation between a leading actor and an assistant actor team are developed in synchronization with Nagauta, Gidayu music and story telling (Japanese classic arts), and a service is provided for the audience watching it. A commentator provides for a comment service about the flow of the play, the characterization of costume and actors, in particular the features of acting and makeup using wireless equipment. For example, interesting comment services can be expected about the relationship between the character of an actor and his makeup—bad/good characters, and its way of expression, the way an actor dresses costume, background and acoustics and their balance.

In Shakespeare's Macbeth, there is virtual setting as a plot. If forest moves as a witch predicts, sometimes a castle collapses. With a scene where a lot of soldiers hold trees assuming forest and their movements looks like the virtual movement of forest as a trigger, the king feels uneasy and finally passes away. In the course, the feeling expression of a scene where the king feels uneasy and passes away psychologically impresses the audience.

As described above, both in the East and the West, feeling expression of joy and anger as the attribute of a performance is given to the audience as a cut scene in the play and elates the feeling of the audience. In this course, an actor and an environment around the actor generate a reciprocal function between the audiences and as a result, enhance a feeling effect.

Next, the structure of feeling is described in more detail. The sensibility of a party as a human being is generated by sensible recognition catching environmental information. Unlike the rational and logical recognition, the sensible recognition is generated from subjectivity and is developed into an abstract recognition. The increase/decrease of the capacity for locomotion by sensible training relates to the economization of energy consumption.

Sensibility is an ability to catch the relationship between environment as spatial data and the physical sense function of a party, and by gradually and continuously abstracting sensibility data, the abstract relationship among a variety of environmental data is converted into environmental data and vice versa. Data is obtained in the external expression in which the reciprocal relationship between a plurality of segments of specific environmental data is abstracted from such a form, and can be appealed to sensibility as specific internal expression through reason.

In the above-mentioned course, the features of thought is also hierarchized, an intention catches a target using feature data and acts on environment as an acting subject. Thus, the intention can be satisfied. In this case, a strategy/tactics control an action.

The fact that the features of a target is sublimated from sensibility in order to specifically operate a service target according to an intention is explained by hierarchizing features, such as a “point”, a “line” and a “surface” as the features of the above-mentioned free-form surface.

In order to hierarchize environmental data as described above, it must be noted that data has the following nature.
(1) Environments can be classified into target areas, can be made open in order to match a variety of targets, and application can be diversified.
(2) The relationship between feature groups of a target can be made orthogonal so that a lot of targets can be operated by a small number of features.
(3) Feature operations can be matched. The reliability and security of operations can be maintained by the matching.

By such openness, orthogonality and matching as a meta-concept, a specific individual disposition is be disinterested. Then, an intention is given priority and acts on environment as an acting subject. Both a client and a server are provided with rich environment as scenery made of a concept and a partial space in environment.

By the above-mentioned process, the contents of environment generate the attribute contents of value, for which money is paid.

A public service is recognized as a social tool with commonality, generates power for coping with the changing circumstances and sensibly fosters an ability to adapt to desirable social changes. In other words, by socially sharing information and sensuously catching environment as a value structure, the structurization of knowledge and intellectualization is made.

Thus, training as an individual sensibility refining method is continued through the active experience of the entire society.

In order to obtain knowledge and intelligence in the above-mentioned process, a “language” as an ability to express environment is necessary. In that sense, the reason for being a human being is the invention of the “language”, and the characters and graphics for expressing the “language” and the process of expressing characters and graphics by the “language” are essential. The “language” can be understood as a bridge between a specific environment and abstraction process.

An information processing language is a bridge for enabling a computer to execute the intention contents of a human being, and is essential for a human being to sensibly catch the execution with a feeling of satisfaction.

The human satisfaction of a party means that a desire as the intention of the party is fulfilled without any complaint and the intention is realized completely. However, a feeling of satisfaction means that the party is sensibly satisfied. Since the sensibility of related parties individually varies, the problem is how much the respective sensibility of the parties can be integrated.

Firstly the intention of a party is defined from the standpoint of an information processing language, an intention as a group is adaptively obtained by a system for calculating a generic union of intentions such that the intentions of parties can be adjusted and matched, and finally the intention of each party is adjusted one after another. The adaptation is made by the system described with reference to FIG. 38. Since feeling recognition data of other parties is related to the degree of satisfaction of sensibility, by feeding back the data to each intention realizing data processing device 353, the attributes A˜N 352 of each intention are adapted to the data.

In this adaptation, a strategy/tactics are adapted to the goal of each intention party in a cooperative team or a contrary team using a support function and a feature extraction function, and the degree of satisfaction is gradually improved by feeling recognition data.

Next, both feeling recognition and structurization are described in more detail. Environment is the information of a target area. The sensibility of a party as a human being catches the information, and the characteristic becomes sensibility data. Firstly the sensibility data is sensibly recognized as a concept by data expressed by a concept of sympathy, for example, by a reciprocal function of eyeballs. The example is described with reference to FIG. 43. In the course of this example, a sympathetic feature concept is sensibly detected by the eyeballs dynamically and partially observing a facial picture, and a structure line indicating their reciprocal relationships are detected by the moving operation of the eyeballs.

As described above, a system for specifying the process of feeling recognition and structurization of a service are described as follows.

(1) Target Area/Target

Assuming that a target area is traffic, its lower-order hierarchical attribute is road traffic and the rental/driving of an automobile or the exchange between a new bullet-train railway and a local line. In solution business, lower-order hierarchical attributes of sub-components in a target area, such as consulting as its core, finance, a pubic service, transaction and the like must be defined.

(2) Intention Structure

When requesting for a service for a target, an intention also has a hierarchical structure although the target has a hierarchical structure. A service intention is also hierarchized, and in order to realize a service, an intention to provide a service must be structurized by a consultant service with a client, corresponding to the hierarchical structure.

The structurization starts by sensibly recognizing what structure each component of a target aimed by a client has. As to a target, the following items are important.
(1) Attribute structure of a target
(2) Relationship among the related operations of a target
(3) Matching relationship among targets
(4) Specific/generic relationship

In (1) above, relationships expressed by “has a”, “part of”, “is a” and the like must be specifically recognized. In (2) above, the situations before, during and after n operation must be expressed by a noun and a verb. (3) above must expresses matching among targets. In (4) above, the hierarchization among components must be specified.

In order not to describe such a comprehensive structure of each target but to describe at least the entire target area, a noun and a verb as related keywords must be formed into a database. For that purpose, a common platform widely developing a service based on an intention structure is necessary in a client-server system.

In order to execute a target according to an intention in a common platform to perform the simulation of each level of sensibility as a starter and the language expression of a service, a WELL system has the following features.
(1) Integrated realization of a variety of media
(2) Configuration of a common platform as the place of interaction
(3) Language design as a notation→Determination of a solution method
(4) Control by constraint items→Connection with feeling data
(5) Model structure: a data model, an object model, a role model and a process model
(6) Intention processing system→Conversion of feeling recognition into feeling and an operation as a team
(7) Security
(8) Network and service function

The above-mentioned items are, for example, expressed and visualized in the form of a graph structure as shown in FIGS. 36 and 37 by the component object of a constraint object. Namely, visibility is increased by a graphic structure, and relationship with a human sensible recognition ability is clarified by linguistic structure. Simultaneously, they can be described in the form of a sentence structure, and can be reciprocally converted by three types of expression paradigms by inclusion logic. Namely, logical exactness is increased by inclusion logic, and interchange is made possible among three types of expression paradigms. Since they correspond to the meaning structure of vocabulary division, the WELL system is made sensibly easy to use.

By digitizing Feeling by feeling recognition and realizing an operation as the reciprocal function of intention between parties, the cooperation and reciprocity in an intention between the parties are promoted.

As described in detail above, in order to provide services based on the opinions of a variety of clients as service-related parties, it is important to structurized an intention realizing system into the base of the entire society, as a solution by the sensibility structure of each party. In particular, a methodology for satisfying clients up to parties in charge taking costs into consideration when the target area of a service rapidly expands with the progress of technologies becomes important as a social infrastructure.

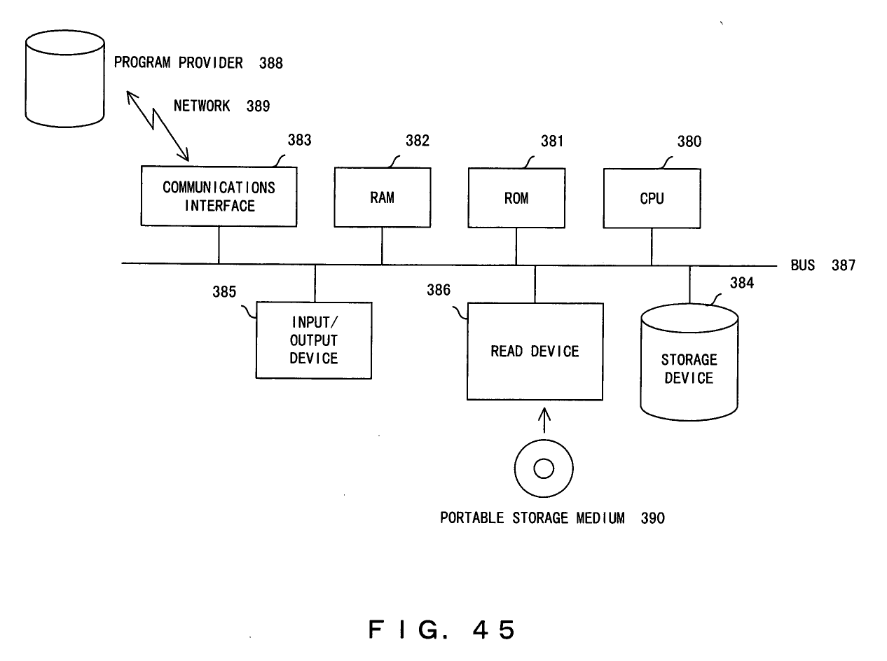

Although the details of the service system based on the sensibility information of the present invention has so far described, the intention realizing data processing device used in this system can be configured as a general-purpose computer system. FIG. 45 is a block diagram showing the configuration of such a computer system, that is, a hardware environment.

In FIG. 45, the computer system comprises a central processing unit (CPU) 380, read-only memory (ROM) 381, random-access memory (RAM) 382, an communication interface 383, a storage device 384, an input/output device 385, a portable storage medium reader device 386 and a bus 387 to which all the components are connected.

For the storage device 384, various forms of storage devices, such as a hard disk, a magnetic disk or the like can be used. The programs and the like shown in the flowcharts of FIGS. 9, 10 and 17 are stored in such a storage device 384 or ROM 381. By making the CPU 380 execute such programs, the service system based on sensibility information in the preferred embodiment can be realized.

Such programs are stored, for example, in the storage device 384 by a program provider 388 through a network 389. Alternatively, such programs can be stored the portable storage medium 390 that is sold and distributed in the market, and be executed by the CPU 380 by setting them in the reader device 386. For the portable storage medium 390, CD-ROM, various forms of storage media, such as a flexible disk, an optical disk, a magneto-optical disk, can be used. By making the reader device 386 read the programs stored in such a storage medium, the degree of satisfaction of a client in the service system in the preferred embodiment can be improved.

The present invention is applicable in all industries providing clients with services by a system using, for example, the Internet.

1. A service system based on sensibility information, for comprehensively realizing a service which satisfies an intention of a plurality of parties, comprising:
a sensibility information acquisition unit obtaining sensibility information of each of the parties about the service in response to at least a part of the plurality of the parties;
intention realizing data processing devices which are an object-oriented data processing device for each of the plurality of parties; for realizing a service which satisfies an intention of the party and has a common platform as an interface function between an object network as a language processing function and the party and
a sensibility data adaptation integration unit controlling each intention realizing data processing device to improve degree of satisfaction with the service for relating target area of at least a part of parties, using sensibility information of at least the part of parties.

2. The service system based on sensibility information according to claim 1, in which object of said object-oriented has a hierarchical structure comprising:
a data model in which the attribute structure is determined as a template;
an object model positioned in order higher than the data model;
a role model positioned in order higher than the object model, expressing contents of a process to be performed in an environment as an aggregate of a plurality of object models; and
a process model positioned in the highest order, defining a dynamic process to be cooperatively performed by a plurality of the role models.

3. The service system based on sensibility information according to claim 2, wherein
said sensibility information acquisition unit divides a target area from which sensibility information of the service is obtained into sub-areas and adds data of feature concepts to each of the sub-area, and simultaneously
said intention realizing data processing device relates the role model to each of the feature concepts and executes a process defined by the process model positioned in order higher than the role model.

4. The service system based on sensibility information according to claim 1, wherein
the sensibility information is supplied to the common platform of the intention realizing data processing device and a process is performed by an operation of data driven corresponding to data in the common platform.

5. The service system based on sensibility information according to claim 1, wherein
each of the plurality of parties belongs to one of two or more teams and each of the teams has a contrary intention each other, and
said intention realizing data processing device for each party in each team comprises an object network determining a strategy and tactics corresponding to the goal of an intention of each team.

6. The service system based on sensibility information according to claim 1, wherein
said common platform displays data indicating the execution status of the service, and simultaneously
said intention realizing data processing device further comprises a process status output unit outputting the execution status as information including sound.

7. The service system based on sensibility information according to claim 1, wherein
matching constraint items are set for the object of each of the models as an attribute of the object, and simultaneously
said intention realizing data processing device further comprises a matching determination unit determining matching of constraints corresponding to the objective of the service.

8. The service system based on sensibility information according to claim 2, further comprising:
a reference model, which is orthogonal to the hierarchical structure composed of the data model, object model, role model and process model, realizing a basic service to be executed in the process of the object network, wherein
said intention realizing data processing device further comprises a contents generation unit generating contents based on the data of a simulation realized by the reference model and displaying the contents.

9. A method of providing a service based on sensibility information, for comprehensively realizing a service which satisfies an intention of a plurality of parties, comprising:
providing a sensibility information acquisition unit obtaining sensibility information of each of the parties about the service in response to at least a part of the plurality of the parties;
providing intention realizing data processing devices which are an object-oriented data processing device for each of the plurality of parties; for realizing a service which satisfies an intention of the party and has a common platform as an interface function between an object network as a language processing function and the party and
providing a sensibility data adaptation integration unit controlling each intention realizing data processing device to improve degree of satisfaction with the service of at least a part of parties, using sensibility information of at least the part of parties.

10. A program of providing a service based on sensibility information, for comprehensively realizing a service which satisfies an intention of a plurality of parties, comprising:
providing a sensibility information acquisition unit obtaining sensibility information of each of the parties about the service in response to at least a part of the plurality of the parties;
providing intention realizing data processing devices which are an object-oriented data processing device for each of the plurality of parties; for realizing a service which satisfies an intention of the party and has a common platform as an interface function between an object network as a language processing function and the party and
providing a sensibility data adaptation integration unit controlling each intention realizing data processing device to improve degree of satisfaction with the service of at least a part of parties, using sensibility information of at least the part of parties.

11. A medium for recording a program enabling a computer to provide a service based on sensibility information, for comprehensively realizing a service which satisfies an intention of a plurality of parties, comprising:
providing a sensibility information acquisition unit obtaining sensibility information of each of the parties about the service in response to at least a part of the plurality of the parties;
providing intention realizing data processing devices which are an object-oriented data processing device for each of the plurality of parties; for realizing a service which satisfies an intention of the party and has a common platform as an interface function between an object network as a language processing function and the party and
providing a sensibility data adaptation integration unit controlling each intention realizing data processing device to improve degree of satisfaction with the service of at least a part of parties, using sensibility information of at least the part of parties.
